(19) United States
(12) Patent Application Publication
(10) Pub. No.: US 2026/0309413 A1
(43) Pub. Date: Oct. 8, 2026

(54) SYSTEMS FOR DRYING OF COMPOSITIONS AND RELATED METHODS

(71) Applicant: Ziccum AB, Lund (SE)

(72) Inventors: Fabrice Rose, Lund (SE); Rasmus Lund, Lund (SE); Per Gerde, Lund (SE)

(21) Appl. No.: 19/479,581

(22) PCT Filed: Apr. 26, 2024
(86) PCT No.: PCT/EP2024/061685

§ 371 Date: Oct. 28, 2025

(30) Foreign Application Priority Data
Apr. 28, 2023 (EP) 23170848.8

(51) Int. Cl. F26B 17/14; B01D 1/14; B01D 1/18; F26B 3/12; F26B 3/16; F26B 25/06

(52) U.S. Cl. CPC F26B 17/14; B01D 1/14; B01D 1/18; F26B 3/12; F26B 3/16; F26B 25/06

(57) ABSTRACT

A drying system is disclosed configured to provide a composition of dry particles from a composition comprising a payload. The drying system comprises a generally cylindrical tube reactor configured for counter-current removal of solvent from a process flow fed with aerosol droplets of solution descending from the top said reactor with an ascending gas flow. The tube reactor comprises: a perforated process tube for transportation of the process flow from an outlet of an aerosol generating device to a dry particle collecting device; a membrane sleeve essentially surrounding the peripheral area of said process tube, the membrane sleeve is configured to separate the descending process flow from the ascending gas flow while admitting diffusion of vaporized solvent from the process flow to the ascending gas flow; a reactor housing. The system comprises a first mass flow regulator configured to control the pressure in the tube reactor by regulating the ascending gas flow.

### FIELD

The invention relates to a drying system and a method for its operation that provides a composition of dry thermostable compositions from a composition comprising a payload. The counter-current drying system refers to the specific flow pattern between the descending carrier gas comprising the composition, such as atomized particles, and the ascending dry gas in the drying chamber of the spray dryer, which facilitates the counter-current drying of the descending droplets.

### BACKGROUND

Historically, the dustgun technology, provides a powerful tool in drug development capable of handling low amounts of powdered compound, i.e. in the mg scale. Yet, this technology, allowing an effective deagglomeration of powders, still require a substrate particle size that is smaller or equal to the desired particle size distribution of the generated aerosols. There are several methods available to provide the dustgun system with powders fine enough to allow generation of respirable aerosols including milling, spray drying and supercritical spray drying. Of these methods, conventional spray drying is the one that has the potential to allow production of very small batches of powder with yields high enough for use with very expensive drug candidates. In milling procedures there are too large losses to the vessel walls and for supercritical spray drying the adjustment of the relatively complicated process tend to consume too much substance before a sufficient quality and quantity of the materials have been obtained.

Even with conventional spray drying systems, commercial as well as custom made ones, the production goal is usually in the scale of grams and upward. This is too much for being optimal for the early synthesis steps in preclinical development. To be optimal for utilizing the dustgun system in early drug development a suitable quantity for powder formulation in a spray dryer system would be in the range of 20-100 mg. With such a small production goal it is possible to reach one important advantage over higher capacity system: to remove most of the solvent vapors from the aerosol stream in the drying column before the particles are separated. Most commercial systems with higher production goals rely on using heated drying gas to quickly evaporate the solvent from the particles before separation of particles from the process flow using filters or cyclones.

However, the high volumetric flow rate through the apparatuses is unsuitable for production goals around 100 mg. Already at higher production goals the product yield of cyclones is usually considerably lower than 60%. The removal of solvent vapors before direct use of the resulting aerosol for inhalation exposures has been previously described. These systems have relied on diffusional drying by passing the process aerosol through a column with vapor-absorptive material accessible through the perforated walls of the drying column. The draw backs of this system are the complicated method by which the absorptive pellets of the drying column regularly must be changed, and the fact that the absorptive material will be contaminated with the dried substances.

Countercurrent drying is commonly used in the food industry for manufacturing of for example powdered milk. However, in these examples the product particles are dried by gravitational settling within the ascending dry air stream (Piatkowski and Zbicinski, 2007). The settling rate of the particles limit production to particles >50 μm. This countercurrent method cannot be used for pharmaceutical agents with a desired product particle size of <5 μm, where settling speeds are in the range of mm/min.

Accordingly, there is need for a spray drying system and system that is adapted for obtaining small quantities of suitably manageable formulation of drug candidates in the form of dry, near solvent free powder, especially a powder with particle size in the range of 1-5 μm, suitable for generating respirable aerosols with the dustgun.

One example can be seen in WO/2009/041900 that describes spray drying system for counter-current removal of solvent. However, there is an ongoing need for improved systems that give higher yields, and which can be adapted for the liquid compositions that are dried.

### SUMMARY

An object of the present invention relates to a drying system adapted to provide a composition of dry particles from a composition comprising a payload, comprising a generally vertical tube reactor arranged for counter-current removal of solvent from a process flow fed with aerosol droplets of solution descending from the top said reactor with an ascending gas flow, characterized in that the tube rector comprises: (i) a perforated process tube for transportation of the process flow from the outlet of an aerosol generating device, capable of generating said aerosol droplets of solution, to a dry particle collecting device; (ii) a membrane sleeve essentially surrounding the peripheral area of said process tube, separating the descending process flow from the ascending gas flow while admitting diffusion of vaporized solvent from the process flow to the ascending gas flow; (iii) a reactor housing sealingly covering said process tube and membrane sleeve being provided with means for introducing and/or removing the process fluids, and wherein the system comprises an element that can introduce energy, such as heat or infrared, into the vertical tube reactor.

One or more embodiments of the present invention relates to a system of the invention, which is a spray drying system.

One or more embodiments of the present invention relates to a system of the invention, wherein the heat element is used to bring heat into the vertical tube reactor from the outside of the vertical tube reactor.

One or more embodiments of the present invention relates to a system of the invention, wherein the heat element is defined by a mantel, heat element, dry bath, incubator and infrared heater.

One or more embodiments of the present invention relates to a system of the invention, wherein the vertical tube reactor comprises means for monitoring the temperature inside the vertical tube reactor.

One or more embodiments of the present invention relates to a system of the invention, wherein one or more of the vertical tube reactor comprises one or more temperature sensors.

One or more embodiments of the present invention relates to a system of the invention, wherein the system comprises means for adjusting the temperature inside the vertical tube reactor.

One or more embodiments of the present invention relates to a system of the invention, wherein the system comprises means for monitoring mass transfer.

One or more embodiments of the present invention relates to a system of the invention, wherein the system comprises means for controlling mass transfer.

One or more embodiments of the present invention relates to a system of the invention, wherein the system comprises means for controlling introducing energy into the column.

One or more embodiments of the present invention relates to a system of the invention, wherein the system comprises means for controlling energy and mass transfer.

One or more embodiments of the present invention relates to a system of the invention, wherein the aerosol generating device located at the top of the tube reactor is a downward acting mesh nebulizer, provided with an opening in its bottom part for dispensing aerosol droplets to the process tube.

One or more embodiments of the present invention relates to a system of the invention, wherein the liquid chamber of the mesh nebulizer receiving the solution of agent is connected with means to establish a pressure below ambient pressure in said chamber.

One or more embodiments of the present invention relates to a system of the invention, wherein the aerosol droplets are in the size range of 1-50 μm.

One or more embodiments of the present invention relates to a system of the invention, provided with means to supply Met gas to the tube reactor from a gas drying column said means comprising an inlet flow rate measuring device located between said process tube and said gas drying column.

One or more embodiments of the present invention relates to a system of the invention, characterized in that it comprises a device introducing inlet gas to the perforated process tube adapted to provide a process flow comprising descending aerosol droplets.

One or more embodiments of the present invention relates to a system of the invention, characterized in that the device is generally annular in cross-section, thereby surrounding the nebulizer opening, and is provided with a plurality of outlet orifices arranged along a peripheral area of said device in order to generate a process flow for transporting and directing the aerosol droplets towards a radial center of the process tube.

One or more embodiments of the present invention relates to a system of the invention, characterized in that the orifices are angled and arranged with outlet channels having a major axis offset to a cross-sectional radius of the inlet gas device.

One or more embodiments of the present invention relates to a system of the invention, wherein the process flow is generated by a vacuum source connected to the bottom of the process tube, the process flow, and/or the ascending gas flow.

One or more embodiments of the present invention relates to a system of the invention, characterized in that the ascending gas flow has a higher flow rate than the descending process flow. The ascending gas flow may be laminar or turbulent.

One or more embodiments of the present invention relates to a system of the invention, characterized in that the ascending gas flow is adapted to perform a swirling motion around the membrane sleeve.

One or more embodiments of the present invention relates to a system of the invention, characterized in that the system comprises a second gas outlet for the ascending gas flow arranged tangentially to the tube reactor. In one or more examples or embodiments, the second gas outlet may be connected to a vacuum source.

One or more embodiments of the present invention relates to a system of the invention, characterized in that the tube reactor has a tangential outlet for the ascending gas flow.

One or more embodiments of the present invention relates to a system of the invention, wherein the flow rate of the ascending gas flow is substantially higher than the descending process flow.

One or more embodiments of the present invention relates to a system of the invention, wherein the ascending flow has a flow rate from about ten to one hundred and fifty times, such as fourteen to sixty times, the value of the descending flow rate to about an equal flow rate value of the descending rate. For example, the ascending gas flow may be in the range of 10 L/min to 150 L/min.

An aspect of the present invention relates to a method of preparing a composition of dry particles from a solution of an agent comprising the steps of: (i) providing a composition comprising a payload to a device for generating an aerosol; (ii) generating a descending process flow in the form of a gas stream of aerosolized droplets with a low flow rate in a perforated process tube; (iii) generating an ascending gas flow for counter-current removal of solvent from said process flow, said ascending flow having substantially higher flow rate than said descending flow; (iv) providing a membrane, separating said process flow and ascending gas flow, permitting diffusive transport of vaporized solvent through from said process flow to said ascending flow for drying the aerosol; and (v) allowing the process flow to descend in the process tube for a time sufficient to substantially remove all solvent vapors before removing the dry particles from said process flow, and wherein the method comprises the option of introducing energy into the tube.

One or more embodiments of the present invention relates to a method of the present invention, wherein the introduction of energy comprises a heat element which is used to bring heat into the tube from the outside of the tube. It may be appreciated that the heat element may compensate for the energy lost during the drying process by providing heat to the tube reactor, such as providing heat from the outside and/or the inside of the tube reactor.

One or more embodiments of the present invention relates to a method of the present invention, wherein descending flow is laminar.

One or more embodiments of the present invention relates to a method of the present invention, comprising sealingly transporting the solvent-rich and/or vapor-rich ascended gas flow leaving the membrane to a solvent absorption column, transporting it through the column for solvent stripping and letting it re-contact the membrane for ascension through the reactor without generating a radial flow of gas through the membrane. It may be appreciated that the solvent absorption column may be present when the drying system is configured to recirculate the ascending gas flow, such as drying flow. The solvent absorption column may for example comprise a silica column.

One or more embodiments of the present invention relates to a method of the present invention, comprising tangentially introducing the ascending gas flow to the tube reactor in order to generate a swirling flow around the membrane.

One or more embodiments of the present invention relates to a method of the present invention, comprising tangentially removing the ascended gas flow from the tube reactor.

One or more embodiments of the present invention relates to a method of the present invention, comprising generating a gently rotating inlet gas flow to the process tube for centrally stabilizing the aerosol dispensed from the aerosol generating device.

One or more embodiments of the present invention relates to a method of the present invention, comprising detecting or monitoring the performance of the aerosol generating device by carefully measuring the inlet gas flow to process tube.

One or more embodiments of the present invention relates to a method of the present invention, comprising detecting and controlling the flow rate of the solvent stripped flow after the absorption column.

One or more embodiments of the present invention relates to a method of the present invention, comprising monitoring the total mass balance of solvent in the system by balancing the disappearance of solvent from the nebulizer against the total outbound flux of solvent from the tube reactor. The total outbound flux may be seen as the ascending gas flow outlet and the process flow outlet.

One or more embodiments of the present invention relates to a method of the present invention, comprising detecting the solvent concentration and flow rates in: (i) the solvent-containing flow before the absorption column, and (ii) the effluent gas stream after the particle-collecting device.

An aspect of the present invention relates to a method for preparing a dry composition comprising by a counter-current spray drying process comprising: (i) providing a liquid composition comprising a payload and at least one excipient, nebulizing said composition into transportable droplets of less than 50 μm in a tube reactor having an inner region and an outer region separated by a perforated process tube with an outer periphery covered by a membrane; (ii) admitting the nebulized composition to descend in a laminar carrier gas flow in said inner region, while admitting a turbulent or laminar flow of dry gas to ascend in said outer region in order to establish a counter-current drying of the descending droplets; (iii) drying the droplets, while admitting vapor to diffuse through the membrane and into the ascending turbulent or laminar flow of dry gas at a rate that exceeds an opposite flow rate of dry gas radially through the membrane; and (iv) collecting a dry composition comprising a payload and at least one excipient.

A drying system is disclosed. The drying system is configured to provide a composition of dry particles from a composition comprising a payload, such as a biopharmaceutical. The drying system comprises a generally cylindrical tube reactor configured for counter-current removal of solvent from a process flow fed with aerosol droplets of solution descending from the top said reactor with an ascending gas flow. The tube reactor comprises a perforated process tube for transportation of the process flow from an outlet of an aerosol generating device, capable of generating said aerosol droplets of solution, to a dry particle collecting device. The tube reactor comprises a membrane sleeve essentially surrounding the peripheral area of said process tube, wherein the membrane sleeve is configured to separate the descending process flow from the ascending gas flow while admitting diffusion of vaporized solvent from the process flow to the ascending gas flow. The tube reactor comprises a reactor housing sealingly covering said process tube and membrane sleeve. For example, the tube reactor may be provided with means for introducing and/or removing process fluids. For example, the tube reactor comprises two or more gas inlets, e.g., for the gas inlet of the process flow and the gas inlet of the ascending gas flow, and two or more gas outlets, e.g., for the gas outlet of the process flow and the gas outlet of the ascending gas flow. The system comprises a first mass flow regulator configured to regulate the ascending gas flow, wherein the first mass flow regulator is configured to control the pressure in the tube reactor by regulating the ascending gas flow.

Further a method of preparing a composition of dry particles from a solution of an agent using the drying system as disclosed herein is disclosed. The method comprises providing a composition comprising a payload to an aerosol generating device. The method comprises generating a descending process flow in the form of a gas stream of aerosolized droplets in a tube reactor having an inner region and an outer region separated by a perforated process tube with an outer periphery covered by a membrane. The method comprises generating an ascending gas flow for counter-current removal of solvent from said process flow. The method comprises controlling the pressure of a tube reactor by regulating the ascending gas flow. The method comprises separating using the membrane said process flow and ascending gas flow, permitting diffusive transport of vaporized solvent through the membrane from said process flow to said ascending flow for drying the aerosol. The method comprises drying the droplets, while admitting vapor to diffuse through the membrane and into the ascending turbulent or laminar flow of dry gas at a rate that exceeds an opposite flow rate of dry gas radially through the membrane. The method comprises collecting a dry composition comprising the payload.

### DETAILED DESCRIPTION

Various examples and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example needs not have all the aspects or advantages shown. An aspect or an advantage described in conjunction with a particular example is not necessarily limited to that example and can be practiced in any other examples even if not so illustrated, or if not so explicitly described.

The figures are schematic and simplified for clarity, and they merely show details which aid understanding the disclosure, while other details have been left out. Throughout, the same reference numerals are used for identical or corresponding parts.

### Definitions

Prior to outlining the present invention in more details, a set of terms and conventions is first defined:

### Composition Comprising a Payload

In the present context, the term “composition comprising a payload” refers to any composition suitable for drying in the system of the present invention, which comprises a payload. The composition of the present invention can be an aqueous or liquid composition, such as a lipid composition.

Thus, in one or more embodiments of the present invention the compositions are aqueous compositions. In one or more embodiments of the present invention the compositions are liquid compositions. In one or more embodiments of the present invention the compositions are lipid compositions.

The amount of water, lipid and other components such as alternative solvents can vary. One example of alternative solvents can be a miscible solvent exemplified by ethanol.

In one or more embodiments of the invention the composition of the present invention can be a nanoparticle composition. The term “nanoparticle” refers to a spherical nanosized vesicle comprising at least one excipient and a payload.

### Lipid Composition

In the present context, the term “lipid composition” refers to any composition that comprises lipids and may be used to deliver a payload to a target, such as a host cell or an individual. The payload, such as nucleic acid material, may be complexed and/or encapsulated within the lipid formulation.

The term lipid is used here in a broader sense and includes, but is not limited to, phospholipids, triglycerides, diglycerides, monoglycerides, fatty acids, steroids, and waxes.

Examples of lipid compositions include, but are not limited to, nanoparticle compositions, lipid nanoparticles (LNPs), liposomes, micelles, nanoemulsions, lipoplexes, cubosomes, and self-emulsifying drug delivery systems (SEDDs).

The lipid composition may be modified with targeting moieties, such as antibodies or peptides, or agents to reduce clearance when introduced in an individual, such as polyethylene glycol (PEG).

### Nucleic Acid Material

In the present context, the terms “nucleic acid material”, and “nucleic acids” refer to biopolymers or shorter biomolecules composed of nucleotides. Nucleic acids comprise both naturally occurring nucleic acids, such as RNA and DNA, as well as nucleic acids analogues (or xeno nucleic acids), such as peptide nucleic acid (PNA), morpholino- and locked nucleic acid (LNA), glycol nucleic acid (GNA), threose nucleic acid (TNA) and hexitol nucleic acid (HNA).

Nucleic acids include also all types of RNA and DNA, such as small interfering RNA (siRNA), small activating RNA (saRNA), microRNA (miRNA), short hairpin RNA (shRNA), ssDNA and dsDNA, as well as larger nucleic acid molecules such as viral vectors.

### Payload

The term payload refers to “nucleic acid material” as defined above as well as biopharmaceutical, peptide, polypeptide, protein, viral vectors.

The main purpose of producing nanoparticle compositions is usually to deliver a medicament, such as a vaccine, to an individual in need thereof. The compositions therefore comprise a payload which can have the desired effect.

The payload can be a biopharmaceutical. The term “biopharmaceutical”, also known as a “biological medical product”, or “biologic”, refers to any pharmaceutical drug product manufactured in, extracted from, or semisynthesized from biological sources. Different from totally synthesized pharmaceuticals, they include vaccines, whole blood, blood components, allergenics, somatic cells, gene therapies, tissues, recombinant therapeutic protein, and living medicines used in cell therapy. Biologics can be composed of sugars, proteins, nucleic acids, or complex combinations of these substances, or may be living cells or tissues. They (or their precursors or components) are isolated from living sources-human, animal, plant, fungal, or microbial. They can be used in both human and animal medicine.

### Excipient

In the present context, the term “excipient” refers to a natural or synthetic substance formulated alongside the active or therapeutic ingredient (an ingredient that is not the active ingredient) of a medication, included for the purpose of stabilization, bulking, or to confer a therapeutic enhancement on the active ingredient in the final dosage form, such as facilitating drug absorption, reducing viscosity, enhancing solubility, adjusting tonicity, mitigating injection site discomfort, depressing the freezing point, or enhancing stability.

Excipients can also be useful in the manufacturing process, to aid in the handling of the dry composition such as by facilitating powder flowability or non-stick properties, in addition to aiding in vitro stability such as prevention of denaturation or aggregation over the is expected shelf life.

Excipients may be added as part of preparation of the lipid formulation or separately as a feedstock when processing the lipid formulation in the counter-current spray drying procedure.

Ionizable and/or Cationic Lipid

In the present context, the term “ionizable cationic lipid” refers to lipids that are positively charged at low pH and neutral at physiological pH. At low pH the positive charges enable complexation with negatively charged nucleic acids. The lipid of the composition according to the present invention can be an ionizable cationic lipid.

### Thermostable

In the present context, the term “thermostable” refers to the ability of a nucleic acid or particle to not undergo change to its chemical or physical structure at temperatures of 20° C. and above (e.g. 40° C.) over a prolonged duration of time. The duration of time may be at least 3 days. Thus, a thermostable dry composition comprises a lipid formulation comprising nucleic acid material that does not undergo significant structural changes and retains its function when stored at ambient conditions. Therefore, the thermostable dry composition comprising a lipid formulation comprising nucleic acid material may retain sufficient amounts of its function when stored at ambient conditions to induce a significant immune response when administered to a recipient.

Thermostable dry compositions may fulfil the stability requirement to be suitable for incorporation in immunogenic compositions or vaccines aiming at obtaining WHO CTC (Controlled Temperature Chain)-approval. CTC approval requires that vaccines can be stored at +40° C. for at least 3 days.

A dry composition comprising a lipid formulation comprising nucleic acid material as referred to herein may be considered thermostable when giving rise to an activity of 60% or greater, such as 70% or greater, such as 80% or greater, after 3 days of storage at a temperature of 20° C. (or alternatively at 40° C.) as compared to the activity induced by the dry composition immediately after spray drying (i.e. defined as 100% activity).

Thermostability can be determined by analyzing how the structure or function of the lipid formulation and/or nucleic acid material changes under exposure to a particular temperature.

Thermostability may for instance be determined by measuring the structure and/or morphology of the lipid formulation over a prolonged period of time (e.g. days). This may be accomplished by analyzing the size distribution of the lipid formulation by dynamic light scattering (DLS) or imaging the lipid formulation using electron miscopy, such as transmission electron microscopy (TEM) or scanning electron microscopy (SEM).

Thermostability can also be determined by assessing whether the nucleic acid material is retained in the lipid formulation when stored for a prolonged period of time (e.g. days). Retention of nucleic acid material can be measured by determination of the encapsulation efficiency in lipid formulation at time zero and after storage. Encapsulation efficiency can be measured using RT-PCR or by the RiboGreen Assay, the latter of which relies on the RiboGreen dye which is fluorescent when bound to ssRNA but which cannot enter the lipid formulation. RT-PCR on the other hand quantifies the total amount of mRNA that is transcribed into cDNA for PCR. The person skilled in the art is familiar with these two methodologies.

Thermostability may also be assessed by analyzing the transfection efficiency of the lipid formulation into the host cells for dry compositions that have been stored for a prolonged period of time (e.g. days).

Moreover, thermostability may be assessed by HPLC to monitor stability of the nucleic acids material. The HPLC methods, include RP-HPLC, SE-HPLC, IP-HPLC and IEX-HPLC, latter of which can be used to determine free and encapsulated nucleic acid material.

### Aerosolizable

In the present context, the term “aerosolizable” refers to a composition that is applicable for use to form a dry aerosol composition with suitable characteristics, such as mass median aerodynamic diameter (MMAD), that is suitably homogenous and coherent following administration with state of the art metered dose inhalers (MDIs) to obtain an effective pulmonary deposition, i.e. to admit the provision of an inhalable vaccine formulation.

### Laminar Flow

In the present context, the term “laminar flow” refers to a fluid (gas or liquid) flow, which can be described as the fluid having constant velocity, pressure and other flow properties at each point of the fluid.

### Flow Rate

The flow rate of the gas is to be understood as the speed of the gas, which can be calculated from the volume of gas moving through a cross sectional area perpendicular to the direction of laminar flow.

### Counter-Current Spray Drying

In the present context, the term “counter-current spray drying” refers to the specific flow pattern between the descending carrier gas comprising the atomized particles and the ascending dry gas in the drying chamber of the spray drier, which facilitates the counter-current drying of the descending droplets. Thus, in a counter-current spray drying configuration, the feed inlet is positioned at the top of drying chamber and the gas (air) inlet is positioned at the bottom of the drying chamber.

Counter-current spray drying is to be distinguished from other conventional spray drying techniques utilizing different configurations, such as co-current flow or mixed flow.

In the present context, the descending flow is laminar. In the present context, the ascending flow is a turbulent or laminar flow. These conditions are established as described herein, i.e. by utilizing the laminar flow counter-current spray drying instrument as disclosed in WO 2009/041900 A1.

Thus, herein, the terms “laminar flow counter-current spray drying”, “counter-current drying”, and “counter-current spray drying” are used interchangeably, noting than these involves laminar flow of the descending flow. The ascending flow is a turbulent or laminar flow.

### Dry Composition

In the present context, the term “dry composition” refers to a composition that is substantially free from moisture. Thus, a dry composition can be a composition with a moisture content of less than 5 wt %, such as 3 wt %, such as 2 wt %.

### Mass Median Aerodynamic Diameter (MMAD)

In the present context, the term “mass median aerodynamic diameter (MMAD)” refers to the aerodynamic diameter at which 50% of the powder particles of the dry composition by mass are larger and 50% are smaller. MMAD influences how inhaled particles are deposited.

MMAD may e.g. be determined by plotting the percentage of mass less than the stated aerodynamic diameter versus particle size in a probability scale against a log particle-size scale and draw a straight line best fitting the plotted points. The MMAD is taken as the intersection of the line with the 50% cumulative percent. If necessary, a weighted least square regression analysis may be used to achieve the best fit. Alternatively, iterative computational methods may be used to determine MMAD.

### Activity

In the present context, the term “activity” refers to the immunogenicity of the antigens, which production is facilitated by the delivery of nucleic acid material comprised in the lipid formulation. Thus, activity is a measure of the magnitude of the immune response elicited by a recipient following administration of the dry composition comprising the lipid formulation comprising nucleic acid material, when challenged with a microorganism comprising the specific antigen or the specific antigen itself. The antigen may be an antigenic protein expressed from the nucleic acid material. Accordingly, a percentage of activity represent the magnitude of the immune response when administered a dry composition that have been stored for a prolonged period of time compared to the immune response when administered a dry composition that have not been stored.

The activity may be determined by measuring an antibody response in a recipient, such as a mouse, challenged with a microorganism, such as a virus or bacterium, comprising the specific antigen or the specific antigen itself. Therefore, it is to be understood, that the immunogenicity is specific to the antigens produced by the recipient of the thermostable dry composition, and it may be referred to as antigenicity as well.

Alternatively, the activity may be measured by determining the presence of specific cytokines or other characteristic indicators of an immune response.

### Adjuvant

In the present context, the term “adjuvant” refers to a compound or mixture that enhances the immune response to an antigen. An adjuvant can serve as a tissue depot that slowly releases the antigen and as a lymphoid system activator, which non-specifically enhances the immune response.

Adjuvants include, but are not limited to, aluminum oxy-hydroxide (AlO(OH)), aluminum hydroxy phosphates (Al(OH)x-(PO4)y), thiomersal, cytokines, complete Freund's adjuvant, incomplete Freund's adjuvant, saponin, mineral gels such as aluminum hydroxide, surface active substances such as lysolecithin, pluronic polyols, polyanions, peptides, oil or hydrocarbon emulsions, keyhole limpet hemocyanins, and dinitrophenol.

### Pharmaceutically Acceptable Carrier

In the present context, the term “pharmaceutically acceptable carrier” or just “carrier” refers to any solvents, dispersion media, vehicles, coatings, diluents, antibacterial and antifungal agents, isotonic and absorption delaying agents, buffers, carrier solutions, suspensions and colloids which are sterile and with which a compound of interest can be administered.

The use of pharmaceutically acceptable carriers is well known in the art and include, but are not limited to, water or aqueous solutions, such as saline solutions, aqueous dextrose, glycerol solutions and sugar-containing solutions, and oils, including those of petroleum, animal, vegetable or synthetic origin.

### About

Wherever the term “about” is employed herein in the context of amounts, for example absolute amounts, such as numbers, purities, weights, sizes, etc., or relative amounts (e.g. percentages, equivalents or ratios), timeframes, and parameters such as temperatures, pressure, etc., it will be appreciated that such variables are approximate and as such may vary by ±10%, for example±5% and preferably ±2% (e.g. ±1%) from the actual numbers specified. This is the case even if such numbers are presented as percentages in the first place (for example ‘about 10%’ may mean±10% about the number 10, which is anything between 9% and 11%).

### Thermostable Lipid Formulations

Nucleic acid-based medicines, hereunder nucleic acid-based vaccines, have great potential and is rapidly revolutionizing modern medicine. However, nucleic acids that are introduced in a recipient is promptly recognized as foreign genetic material and degraded by the host. To overcome this and the inherent physiochemical properties of nucleic acids that hinders transfer into host cells, many nucleic acid-based medicines are provided as formulations designed to protect and effectively deliver the nucleic acid across the host cell membrane.

Lipid-based formulations are often used as delivery systems providing a protective environment for the nucleic acid material and facilitating transport across the cell membrane. A large selection of lipids already exists or can in many cases be modified to tailor the properties to specific delivery systems and applications, e.g. by adding targeting moieties, reporter agents or agents to increase storage stability and circulation times. Further, most lipids are considered generally recognized as safe (GRAS) substances that are both biocompatible and biodegradable, thereby making lipid systems excellent choices for medical formulations.

The Covid-19 pandemic and the successful development of Covid-19 mRNA vaccines has highlighted the promises of advanced material sciences for nucleic acid-based medicine. The mRNA vaccines rely on delivery of mRNA into the cytoplasm of host cell from where it can be transcribed to antigenic proteins that induces an immune response. The challenge has been to transport the mRNA to its site of action since the size and negative charge has prevented diffusion across the cell membrane.

Formulation of nucleic acids in lipid vehicles has therefore played a key role in the successful advancement of the of Covid-19 mRNA vaccines and the technology is now at a point where mRNA vaccines is the key weapon against the ongoing pandemic.

While the available mRNA vaccines are a magnificent achievement, the mRNA vaccines still suffer from the drawback that refrigerated conditions must be maintained to avoid spoilage of the labile biological material. Long term storage of the two mRNA vaccines of BioNTech/Pfizer and Moderna requires freezing conditions, −60 to −90° C. and −15 to −25° C., respectively. In fact, most existing and future liquid nucleic acid-based medicines will rely on strict cold-chain requirements as the biological material, such as nucleic acids or antigens, typically requires +2° C. to +8° C. for short term storage and freezing conditions, maybe even −80° C., for long term storage. These demanding requirements are both expensive and, in many cases, not feasible in e.g. developing countries or remote regions. Thus, these types of treatments are not available to everyone.

To improve accessibility of lipid formulations comprising nucleic acid material, hereunder mRNA vaccines, the complex cold-chain requirements must be eliminated. This may be accomplished by providing the lipid formulations as a dry powder, thereby reducing the risk of hydrolysis, oxidation and deamidation events of the biological material. However, conventional drying technologies either freeze or heat substances. Working at non-ambient temperatures significantly reduces the chance of delicate, temperature-sensitive biologics, such as nucleic acids, remaining active after the drying process. Moreover, the elevated temperatures of conventional spray drying techniques (e.g. above 100° C.) may cause lipids of the lipid formulation to melt and/or aggregate, which interrupts flow through the inlet nozzle and intervenes with uniform particle formation.

Herein are provided methods that allow production of thermostable dry compositions comprising lipid formulation comprising nucleic acid material that can readily be used for preparation of dry powder vaccines (DPVs). The provision of immunogenic compositions that obviate the need for cold-chain storage and transport enables vaccine developers to gain WHO CTC (Controlled Temperature Chain)-approval. CTC approval requires that vaccines can be transported outside the cold chain at +40° C. for at least three days. CTC labelling is a new part of the WHO's mission to vaccinate more people worldwide without having to rely on costly, complex cold-chain refrigeration systems. Thus, the thermostable dry powder compositions provided herein could potentially lead to a significant global increase in the number of people worldwide who can be vaccinated.

The drying system and method as disclosed herein may be seen as for providing a composition of dry particles from a composition comprising a payload, such as a biopharmaceutical. In other words, the drying system and method as disclosed herein may be seen as for removal of solvent, such as solvent vapor, from a solution comprising the composition (such as payload and/or excipient) and the solvent. For example, the drying system and method as disclosed herein may be seen as for removal of solvent vapor from aerosol droplets comprising the composition and the solvent. The tailored method disclosed herein includes micronization of lipid formulations comprising nucleic acid material at ambient temperature utilizing a counter-current spray drying setup. In brief, the method is based on removal of solvent vapor from the droplet containing the composition (e.g., payload and/or excipient), such as lipid formulation, prior to the composition, such as lipid formulation, being separated from the process flow, e.g., solidified. The drying system and method as disclosed herein may be seen as for mass transferring the mass of the solvent in the solution comprising the composition, from the process flow to the ascending gas flow (such as drying flow) through the membrane. This may be accomplished by using laminar flows of descending carrier gas (e.g., process flow), wherein the dry gas (e.g., ascending gas flow) passes on the outside of a vapor-permeable membrane covering a perforated tube in which the composition, such as lipid formulation, travels with the carrier gas. Thus, solvent absorption occurs upon migration of the lipid formulation through the perforated tube as the membrane effectively separates the gas streams while allowing diffusing vapor to transfer to the outside of the perforated tube. In other words, the solvent vapor and the solid part of the solution or composition, such as the dry particles, are separated. It may be appreciated that the solvent vapor and the solid part of the solution or composition, such as the dry particles, are separated at least partially via a diffusion process from the process tube to the ascending gas flow (such as outer tube) through the membrane. For a more detailed description of the setup, reference is made to WO 2009/041900 A1. Utilizing this setup, it is found that lipid formulation remains thermostable as a functional dry powder composition when stored at ambient temperature for extended periods of time. Without being bound by theory, it is contemplated that the ability to remove water from the composition in a gentle and efficient manner increases stability since hydrolysis of nucleic acid material in water containing lipid formulation is suggested to be a key driver for instability during storage under non-frozen conditions.

The present invention relates to an improved setup which includes monitoring of various parameters, including pressure, humidity and temperature. The inventors have surprisingly found that this improved setup can generate improved output and higher yields. This is for example shown in example 1, which shows that the evaporation is lowering the temperature significantly inside the vertical tube reactor. One solution to this problem has been to introduce energy from outside the vertical tube in order to compensate for the lower temperature. This energy compensation has surprisingly shown to be highly beneficial in for example the dry composition output with as much as 22% added output (see example 1).

Thus, an embodiment of the present invention relates to the system and method as described herein, wherein the droplets in step (iv) are dried at an ambient temperature in the range of about 15° C. to about 30° C. Depending on the specific lipid formulation and type of nucleic acid material, different drying temperatures may be preferred. Common to the temperatures of the present method is that they are not high enough to significantly damage the biological material during its residence time in the reactor tube.

Another embodiment of the present invention relates to the system and method as described herein, wherein the droplets in step (iv) are dried at an ambient temperature in the range of about 15° C. to about 30° C., such as about 15° C. to about 25° C., such as about 18° C. to about 23° C., such as about 19° C. to about 22° C.

Thus, a further embodiment of the present invention relates to the method as described herein, wherein the droplets in step (iv) are dried over a time period of at least about 30 seconds, such as at least about 40 seconds, such as at least about 50 seconds, such as at least about 60 seconds, such as at least about 90 seconds, such as at least about 120 seconds. The person skilled in the art will recognize that in some embodiments the period of drying should not be prolonged to an extent that would inevitably damage the biological material.

Yet another embodiment of the present invention relates to the method as described herein, wherein the droplets in step (iv) are dried over a time period in the range of about 30 seconds to about 120 seconds.

Upon descension as transportable droplets in the inner region of the tube reactor the solvent of the liquid composition evaporates. The final dry composition may comprise a relatively high amount of excipient as the solvent evaporates from the liquid composition during processing. Suitably, the liquid composition may comprise 0.1-30 wt % excipient with respect to the total weight of the liquid composition. Thus, an embodiment of the present invention relates to the method as described herein, wherein the liquid composition of step (i) comprises between 0.1-30 wt % excipient with respect to the total weight of the liquid composition, such as 1-25 wt %, preferably 5-20 wt % excipient with respect to the total weight of the liquid composition. Another embodiment of the present invention relates to the method as described herein, wherein the liquid composition of step (i) comprises approximately 20 wt % excipient with respect to the total weight of the liquid composition.

The tube reactor may be configured with a sealed loop arranged for recirculating the ascending dry gas flow once it has taken up vapor diffusing across the membrane to become solvent-filled (or solvent-rich). Accordingly, it is to be understood that the dry gas is substantially free of any solvent or liquid when initially admitted into the outer region of the tube reactor. The ascending dry gas may be air or nitrogen.

Thus, an embodiment of the present invention relates to the method as described herein, wherein the ascending dry gas is air or nitrogen, such as compressed air or nitrogen.

The solvent-filled ascending gas, e.g. air or nitrogen, may be transferred to a separate column capable of absorbing the solvent followed by recirculation back to the tube reactor. The solvent absorption material can be adapted for specific collection of solvent and other process conditions, such stripping columns are known in the field of technology.

However, in a preferred embodiment there is no recirculation, and the gas is simply flowing through the system.

In another preferred embodiment, the gas can be air but is preferably nitrogen, which optionally can be compressed nitrogen.

The progression of the drying process may be monitored by tracking the influx and outflux of solvent in the system. Thus, an embodiment of the present invention relates to the method as described herein, said method further comprising monitoring the total mass balance of solvent in the system by balancing the disappearance of solvent from the nebulizer against the total outbound flux of solvent from the tube reactor.

The flow rates of the descending and ascending gas flows may advantageously be adjusted and configured to support efficient drying of the nebulized liquid composition in the tube reactor.

An embodiment of the present invention relates to the method as described herein, wherein the flow rate of the ascending gas is higher than the flow rate of the descending gas.

Another embodiment of the present invention relates to the method as described herein, wherein the ratio of the flow rate of the ascending gas to the flow rate of the descending gas is in the range of about 10 to about 150, such as 14 to about 60.

Still another embodiment of the present invention relates to the method as described herein, wherein the flow rate of the ascending gas is at least 2 times higher than the flow rate of the descending gas, such at least 3 times higher, such at least 4 times higher, such at least 5 times higher, such at least 6 times higher, such at least 7 times higher, such at least 8 times higher, such at least 9 times higher, such at least 10 times higher, such at least 14 times higher, such at least 20 times higher, such at least 30 times higher, such at least 40 times higher, such at least 50 times higher, such at least 60 times higher, such as at least 100 times higher, such as at least 150 times higher. Thus, the flow rate of the ascending flow has a flow rate from about ten to one hundred fifty times the value of the flow rate of the descending gas.

Yet another embodiment of the present invention relates to the method as described herein, wherein the ascending flow circulates in a spiral around the membrane. In other words, the ascending flow is moving in the outer region of the tube reactor in a spiral around in the inner region of the tube reactor. One or more embodiments of the present invention relates to a system of the invention, characterized in that the tube reactor has a tangential outlet for the ascending gas flow. One or more embodiments of the present invention relates to a system of the invention, wherein the flow rate of the ascending gas flow is substantially higher than the descending process flow. One or more embodiments of the present invention relates to a system of the invention, wherein the ascending flow has a flow rate from about six times the value of the descending flow rate to about an equal flow rate value of the descending rate. The inner flow (Descending flow) can be from 1 to 2.5 L/min and the drying flow (Ascending flow) from 10 to 150 L/min, such as 35 to 60 L/min.

A further embodiment of the present invention relates to the method as described herein, wherein the spiral flow around the membrane is generated by introducing the ascending dry gas flow tangentially into the tube reactor. Another embodiment of the present invention relates to the method as described herein, wherein the spiral flow around the membrane is further supported by tangentially removing the ascended gas flow from the tube reactor.

When the ascending gas moves as a spiral flow around the membrane, it has a longer flow path and residence time in the outer region of the tube reactor. This results in the ascending gas remaining in contact with the membrane for a longer period, allowing sufficient contact time even when using a high difference in flow rates between the ascending and descending gases.

The two counter-current streams are separated with the vapor-permeable membrane. The membrane reduces or minimizes convectional mixing between the descending and ascending gas streams but allows diffusional equilibration of solvent vapor from high to low concentration. The membrane may advantageously be a thin sheet admitting diffusion of vaporized solvent with a controlled sorbing capacity of the solvent. The membrane can be treated with agents to modify its sorbing capacity in order to adapt to different solvents having different polarity or other chemical characteristics.

Thus, an embodiment of the present invention relates to the system and method as described herein, wherein the membrane is made of paper, such as rice paper. This type of membrane is suitable when the solvent is aqueous. One or more embodiments of the present invention relates to a system of the invention, wherein the membrane sleeve is a thin sheet admitting diffusion of the solvent from process flow to the ascending flow, preferably said membrane has a controlled solvent sorbing capacity; more preferably said sheet is paper sheet having a specific weight of about 14 grams per square meter. In one or more examples or embodiments, the membrane or sheet may comprise one or more of: paper, such as including rice paper, other polymer membranes with hydrophilic or hydrophobic surfaces, e.g., modified cellulose, polyether sulfone, PES, and nylon.

Another embodiment of the present invention relates to the method as described, wherein the membrane is coated with an agent that alter the sorbing capacity of the membrane.

The particles of the dry composition may be collected on a filter upon leaving the process flow. This filter may preferably be a nylon filter. Thus, an embodiment of the present invention relates to the method as described herein, wherein the dry composition is collected on a filter, such as a nylon filter.

Alternatively, the particles of the dry composition may be collected in a container, such as a tank suitable for accumulating and/or storing the particles. The container may be adapted for ejecting the carrier gas from the inner region of the tube reactor, e.g. through an outlet, such as a vent. The vent may comprise a filter, e.g. to prevent the dry composition from exiting the container.

Thus, an embodiment of the present invention relates to the method as described herein, wherein the particles of the dry composition are collected in a collecting container. Another embodiment of the present invention relates to the method as described herein, wherein the collecting container comprises a vent for ejecting the carrier gas.

The composition comprising a payload that is nebulized to droplets comprises at least one excipient which may act as a bulking agent during the drying process and contribute to stabilization of the resulting thermostable and/or dry composition. The at least one excipient may be added during preparation of the compositions, such as a lipid formulation, e.g. in a buffer, as part of a rehydration medium or as an additive in a process step. Thus, the at least one excipient may form part of the compositions, such as the lipid formulation, prior to the counter-current spray drying process. Alternatively, the at least one excipient may be absent from the compositions, such as the lipid formulation, and instead be added separately to form the liquid composition for nebulization prior to the counter-current spray during process. Thus, an embodiment of the present invention relates to the method as described herein, wherein the compositions, such as the lipid composition, comprises said at least one excipient.

Another embodiment of the present invention relates to the method as described herein, wherein the at least one excipient is added separately to the liquid composition in step (i) prior to nebulization in step (ii).

Newly developed as well as already existing lipid compositions comprising nucleic acid material may benefit from the method described herein. Thus, it is contemplated herein that existing compositions comprising such lipid formulation, such as nucleic acid-based vaccines, may benefit from being prepared or treated by the method as described herein. Thus, by the using counter-current spray drying process described herein existing vaccines that are currently dependent on cold chain transport and storage may be reformulated as thermostable vaccines and thereby become available to broader population.

Accordingly, an embodiment of the present invention relates to the method as described herein, wherein the lipid formulation comprising nucleic acid material is a commercially available medical formulation. Another embodiment of the present invention relates to the method as described herein, wherein the lipid formulation comprising nucleic acid material is a medical formulation approved by the FDA and/or EMA. A further embodiment of the present invention relates to the method as described herein, wherein the lipid composition comprising nucleic acid material is an mRNA vaccine.

Thermostable dry compositions comprising a lipid formulation comprising nucleic acid material and at least one excipient can be obtained in high yields and without compromising the integrity of the nucleic acid material using the counter-current spray drying process described herein.

Thus, an object of the present invention relates to a drying system adapted to provide a composition of dry particles from a composition comprising a payload, such as a biopharmaceutical, comprising a generally vertical tube reactor arranged for counter-current removal of solvent from a process flow fed with aerosol droplets of solution descending from the top said reactor with an ascending gas flow, characterized in that the tube rector comprises: (i) a perforated process tube for transportation of the process flow from the outlet of an aerosol generating device, capable of generating said aerosol droplets of solution, to a dry particle collecting device; (ii) a membrane sleeve essentially surrounding the peripheral area of said process tube, separating the descending process flow from the ascending gas flow while admitting diffusion of vaporized solvent from the process flow to the ascending gas flow; (iii) a reactor housing sealingly covering said process tube and membrane sleeve being provided with means for introducing and/or removing the process fluids, and wherein the system comprises an element that can introduce energy into the vertical tube reactor. The energy can be heat or infrared. One or more embodiments of the present invention relates to a system of the invention, which is a spray drying system. The particles that are generated from the system and the methods of the present invention can be thermostable dry particles, or a powder. The aerosol generating device can be a nebulizer. The composition comprising a payload can be a nanoparticle composition.

The composition comprising a payload can be a lipid composition as defined earlier, and it can be comprising; a cationic and/or ionizable lipid, a phospholipid, a structural lipid, a payload, optionally a PEG lipid, and optionally additional components. The composition that is dried in the system can therefore be comprising water and is thus an aqueous composition. The composition can also be a liquid composition if there are alternative solvents.

The heat element is selected from the group consisting of a mantel, heat element, dry bath, a resistance element, an incubator, and infrared heater. One or more embodiments of the present invention relates to a system of the invention, wherein the vertical tube reactor comprises means for monitoring the temperature inside the vertical tube reactor. Thus, one or more embodiments of the present invention relates to a system of the invention, wherein the tube reactor comprises one or more temperature sensors. The monitoring can be done through a cable or wireless communication. For example, the temperature sensor(s) may transmit temperature data (such as temperature signal) via wire or wirelessly. In the present disclosure, all or some of the elements of the system such as the temperature sensors, humidity sensors, pressure sensors, and/or mass flow regulators may be connected to programmable logic controllers, PLCs.

One or more embodiments of the present invention relates to a system of the invention, wherein the system comprises means for adjusting the temperature inside the vertical tube reactor. Such means can e.g. be thermostat, which can be working electronically.

Similarly, it will be possible to monitor the transfer of mass, i.e. water (liquid) using sensors. This, one or more embodiments of the present invention relates to a system of the invention, wherein the system comprises means for monitoring mass transfer.

The drying system may be configured to control one or more of: the heat element, the process flow, the ascending gas flow, and the aerosol generating device, such as a spray rate of the aerosol generating device. The drying system may thereby be configured to change the mass transfer, such as mass transfer rate, of a solution by controlling one or more of the above parameters. It may be appreciated that the mass transfer of a solution may also depend on the nature and/or type of the solution. One or more embodiments of the present invention relates to a system of the invention, wherein the system comprises means for controlling mass transfer. For energy e.g. heat, this is also the case which means that the system comprises means for controlling introducing energy into the column.

This can be combined in the system so that there are combined means for controlling energy and mass transfer.

One or more embodiments of the present invention relates to a system of the invention, wherein the aerosol generating device located at the top of the tube reactor is a downward acting mesh nebulizer, provided with an opening in its bottom part for dispensing aerosol droplets to the process tube.

One or more embodiments of the present invention relates to a system of the invention, wherein the liquid chamber of the mesh nebulizer receiving the solution of agent, e.g. the composition, is connected with means to establish a pressure below ambient pressure in said chamber.

One or more embodiments of the present invention relates to a system of the invention, provided with means to supply Met gas to the tube reactor from a gas drying column said means comprising an inlet flow rate measuring device located between said process tube and said gas drying column.

One or more embodiments of the present invention relates to a system of the invention, characterized in that it comprises a device introducing inlet gas to the perforated process tube adapted to provide a laminar process flow comprising descending aerosol droplets.

One or more embodiments of the present invention relates to a system of the invention, characterized in that the device is generally annular in cross-section, thereby surrounding the nebulizer opening, and is provided with a plurality of outlet orifices arranged along a peripheral area of said device in order to generate a process flow for transporting and directing the aerosol droplets towards a radial center of the process tube.

One or more embodiments of the present invention relates to a system of the invention, characterized in that the orifices are angled and arranged with outlet channels having a major axis offset to a cross-sectional radius of the inlet gas device. One or more embodiments of the present invention relates to a system of the invention, wherein the process flow is generated by a vacuum source connected to the bottom of the process tube and a gas inlet of the process flow. The vacuum source may be connected to the gas outlet of the process flow. One or more embodiments of the present invention relates to a system of the invention, characterized in that the ascending gas flow is a turbulent or laminar flow with a higher flow rate than the descending process flow. One or more embodiments of the present invention relates to a system of the invention, characterized in that the ascending gas flow is adapted to perform a swirling motion around the membrane sleeve. One or more embodiments of the present invention relates to a system of the invention, characterized in that the system comprises a second gas outlet for the ascending gas flow arranged tangentially to the tube reactor. In one or more examples or embodiments, the second gas outlet may be connected to a vacuum source.

One or more embodiments of the present invention relates to a system of the invention, comprising an electrostatic charge neutralizer located in the vicinity of the opening of the aerosol generating device.

An aspect of the present invention relates to a method of preparing a composition of dry particles from a solution of an agent comprising the steps of: (i) providing a composition comprising a payload to a device for generating an aerosol; (ii) generating a descending process flow in the form of a gas stream of aerosolized droplets with a low flow rate in a perforated process tube; (iii) generating an ascending gas flow for counter-current removal of solvent from said process flow, said ascending flow having substantially higher flow rate than said descending flow; (iv) providing a membrane, separating said process flow and ascending gas flow, permitting diffusive transport of vaporized solvent through from said process flow to said ascending flow for drying the aerosol; and (v) allowing the process flow to descend in the process tube for a time sufficient to substantially remove all solvent vapors before removing the dry particles from said process flow, and wherein the method comprises the option of introducing energy into the tube. One or more embodiments of the present invention relates to a system of the invention, wherein the aerosol droplets are in the size range of 1-50 μm, such as 4-50 μm. A preferred particles size may for example be in the range of 5-15 μm, such as around 10 μm.

An further aspect of the present invention relates to a method for preparing a dry composition comprising by a counter-current spray drying process comprising: (i) providing a liquid composition comprising a payload and at least one excipient, nebulizing said composition into transportable droplets of less than 50 μm in a tube reactor having an inner region and an outer region separated by a perforated process tube with an outer periphery covered by a membrane; (ii) admitting the nebulized composition to descend in a laminar carrier gas flow in said inner region, while admitting a turbulent or laminar flow of dry gas to ascend in said outer region in order to establish a counter-current drying of the descending droplets; (iii) drying the droplets, while admitting vapor to diffuse through the membrane and into the ascending turbulent or laminar flow of dry gas at a rate that exceeds an opposite flow rate of dry gas radially through the membrane; and (iv) collecting a dry composition comprising a payload and at least one excipient.

One or more embodiments of the present invention relates to methods of the present invention, wherein the introduction of energy comprises a heat element which is used to bring heat into the tube from the outside of the tube. One or more embodiments of the present invention relates to methods of the present invention, wherein descending flow is laminar. One or more embodiments of the present invention relates to methods of the present invention, comprising sealingly transporting the solvent-rich ascended gas flow leaving the membrane to a solvent absorption column, transporting it through the column for solvent stripping and letting it re-contact the membrane for ascension through the reactor without generating a radial flow of gas through the membrane. It may be appreciated that the solvent absorption column may be present when the drying system is configured to recirculate the ascending gas flow, such as drying flow. One or more embodiments of the present invention relates to methods of the present invention, comprising tangentially introducing the ascending gas flow to the tube reactor in order to generate a swirling flow around the membrane. One or more embodiments of the present invention relates to methods of the present invention, comprising tangentially removing the ascended gas flow from the tube reactor. One or more embodiments of the present invention relates to methods of the present invention, comprising generating a gently rotating inlet gas flow to the process tube for centrally stabilizing the aerosol dispensed from the aerosol generating device. One or more embodiments of the present invention relates to methods of the present invention, comprising detecting or monitoring the performance of the aerosol generating device by carefully measuring the inlet gas flow to process tube. One or more embodiments of the present invention relates to methods of the present invention, comprising detecting and controlling the flow rate of the solvent stripped flow after the absorption column. One or more embodiments of the present invention relates to methods of the present invention, comprising monitoring the total mass balance of solvent in the system by balancing the disappearance of solvent from the nebulizer against the total outbound flux of solvent from the tube reactor. One or more embodiments of the present invention relates to methods of the present invention, comprising detecting the solvent concentration and flow rates in: (i) the solvent-containing flow before the absorption column, and (ii) the effluent gas stream after the particle-collecting device.

A drying system is disclosed. The drying system is configured to provide a composition of dry particles from a composition comprising a payload, such as a biopharmaceutical. The drying system comprises a generally cylindrical tube reactor configured for counter-current removal of solvent from a process flow fed with aerosol droplets of solution descending from the top said reactor with an ascending gas flow.

The process flow may be seen as an inlet flow of gas being fed with aerosol droplets. The droplet of solution may be seen as comprising the payload and the solvent that the payload is dissolved in. The ascending gas flow may be seen as the drying flow as disclosed herein.

The cylindrical tube reactor may be seen as the vertical tube reactor as disclosed herein. The tube reactor comprises a perforated process tube for transportation of the process flow from an outlet of an aerosol generating device, capable of generating said aerosol droplets of solution, to a dry particle collecting device. The tube reactor comprises a membrane sleeve essentially surrounding the peripheral area of said process tube, wherein the membrane sleeve is configured to separate the descending process flow from the ascending gas flow while admitting diffusion of vaporized solvent from the process flow to the ascending gas flow. In other words, the membrane sleeve is configured to separate the descending process flow from the ascending gas flow while admitting diffusion of vaporized solvent from the aerosol droplets to the ascending gas flow.

The membrane may be seen as configured to separate the tube reactor into two chambers or volumes, e.g., an inner column, such as process tube, and an outer column, such as the drying column.

The tube reactor comprises a reactor housing sealingly covering said process tube and membrane sleeve. The tube reactor may be provided with means for introducing and/or removing process fluids. For example, the tube reactor comprises two or more gas inlets, e.g., for the gas inlet of the process flow and the gas inlet of the ascending gas flow, and two or more gas outlets, e.g., for the gas outlet of the process flow and the gas outlet of the ascending gas flow. The system comprises a first mass flow regulator configured to regulate the ascending gas flow. The first mass flow regulator is configured to control the pressure in the tube reactor by regulating the ascending gas flow. In other words, the first mass flow regulator may be configured to control the differential pressure or absolute pressure in the tube reactor by regulating the ascending gas flow. The first mass flow regulator may be seen as pressure controlled.

The first mass flow regulator may allow to apply an overpressure or underpressure in the tube reactor with respect to the surrounding atmospheric pressure. The pressure, such as overpressure or underpressure, applied may for example be in the range of −100-+100 mbar mbar in absolute pressure or differential pressure, such as 25 mbar. Applying an overpressure in the tube reactor may in turn facilitate the use of an inert gas, such as nitrogen, for the process flow and the ascending gas flow. For example, the use of overpressure, such as the control of overpressure, may allow to avoid contamination in the tube reactor, e.g., by sucking gas in from outside the tube reactor. Furthermore, applying overpressure may help retain the liquid (such as solution) in the aerosol generating device, e.g., avoid dripping from the aerosol generating device. The use of underpressure may for example avoid having product (such as toxic or harmful products) escape or release from the drying system, such as escape the tube reactor.

In one or more example drying systems, the drying system comprises a first pressure sensor at an outlet of the ascending gas flow. In one or more example drying systems, the first pressure sensor is configured to provide a first pressure signal to the first mass flow regulator. In one or more example drying systems, the first mass flow regulator is configured to control the pressure in the tube reactor by regulating the ascending gas flow based on the first pressure signal.

The drying system for example comprises the first pressure sensor after the outlet of the ascending gas flow from the tube reactor.

In one or more example drying systems, the drying system comprises a second mass flow regulator configured to regulate the process flow.

In one or more example drying systems, the drying system comprises a second pressure sensor at an inlet of the process flow. In one or more example drying systems, the second pressure sensor is configured to provide a second pressure signal. In one or more example drying systems, the second mass flow regulator is configured to regulate the process flow based on the second pressure signal.

The drying system for example comprises the second pressure sensor before the inlet of the process flow, e.g., before an inlet of the inlet flow.

In one or more example drying systems, the drying system comprises one or more static pressure sensors configured to measure a pressure difference between the outlet of the ascending gas flow, the inlet of the process flow, and the outlet of the process flow. In one or more examples or embodiments, the drying system comprises a differential pressure transmitter for transmitting the measured pressure difference.

In one or more example drying systems, the drying system comprises a first humidity sensor at an outlet of the ascending gas flow and a third humidity sensor at an inlet of the ascending gas flow. In one or more example drying systems, the first humidity sensor is configured to provide a first humidity signal and the third humidity sensor is configured to provide a third humidity signal. In one or more example drying systems, the drying system is configured to determine a humidity parameter of the outlet of the ascending gas flow based on the first humidity signal and/or the third humidity signal.

The drying system is for example configured to determine a humidity parameter of the humidity parameter of inlet of ascending gas flow. For example, the drying system may compare a humidity of the ascending gas flow at an inlet of the ascending gas flow and at an outlet of the ascending gas flow, e.g., to determine and/or monitor a mass transfer in the tube reactor.

In one or more example drying system, the drying system comprises a second humidity sensor at an inlet of the process flow and a fourth humidity sensor at an outlet of the process flow. In one or more example drying systems, the second humidity sensor is configured to provide a second humidity signal. In one or more example drying systems, the fourth humidity sensor is configured to provide a fourth humidity signal. In one or more example drying systems, the drying system is configured to determine a humidity parameter of the outlet of the process flow based on the second humidity signal and/or the fourth humidity signal.

In one or more example drying systems, the first humidity sensor, the second humidity sensor, the third humidity sensor, and/or the fourth humidity sensor comprise a dew point sensor.

In one or more example drying systems, the first humidity sensor, the second humidity sensor, the third humidity sensor, and/or the fourth humidity sensor comprise a first dew point sensor, second dew point sensor, a third dew point sensor, and/or a fourth dew point sensor respectively.

In one or more example drying systems, the drying system comprises one or more temperature sensors configured to provide one or more temperature signals.

In one or more examples or embodiments, the tube reactor comprising one or more temperature sensors and/or the dew point sensors comprising a temperature sensor.

In one or more example drying systems, the drying system is configured to monitor mass transfer of solvent based on one or more of: the first humidity signal, the second humidity signal, the third humidity signal, the fourth humidity signal, the process flow, the ascending gas flow, and the one or more temperature signals.

In one or more example drying systems, the drying system comprises a heat element configured to provide energy into the tube reactor. In other words, the heat element may be configured to provide energy or heat for compensating for an energy loss in the tube reactor, e.g., due to evaporation and temperature of gas flows.

In one or more example drying systems, the heat element is configured to bring heat into the tube reactor from the outside of the tube reactor.

The heat element is for example configured to bring heat into the tube reactor from the outside of the tube reactor by heating up the tube reactor from outside and transferring the heat via the material of the tube reactor, such as via walls of the tube reactor.

In one or more example drying systems, the heat element is selected from the group consisting of one or more of: a mantel, a dry bath, a resistance element, an incubator, and an infrared heater. In one or more examples or embodiments, the heat element may comprise a heat element configured to heat the gas of the process flow and/or the ascending gas flow before being inserted in the tube reactor.

In one or more example drying systems, the drying system is configured to control mass transfer of solvent by controlling one or more of: the heat element, the process flow, the ascending gas flow, and a spray rate of the aerosol generating device.

The drying system may for example control mass transfer of the solvent by monitoring the mass transfer and getting feedback on the mass transfer.

In one or more example drying systems, the drying system is configured to determine a temperature inside the tube reactor.

The drying system may be configured to determine the temperature inside the tube reactor based on one or more of: the one or more temperature outputs, and the one or more humidity outputs. The heat element is for example controlled based on a signal from the temperature sensor.

In one or more examples or embodiments, the drying system comprises processor circuitry configured to control one or more of: the temperature in tube reactor (such as by controlling the heat element), the pressure in the tube reactor, the aerosol generating device, the process flow, and the ascending gas flow. In turn, the processor circuitry may then control the mass transfer by monitoring and regulating one or more of the above parameters. It may be appreciated that the processor circuitry may be operatively connected to one or more of the: heat element, mass flow regulators, temperature sensors, humidity sensors, dew point sensors, and pressure transmitters for controlling one or more of above parameters and in turn the mass transfer.

In one or more example drying systems, the aerosol generating device located at the top of the tube reactor is a downward acting mesh nebulizer, provided with an opening in its bottom part for dispensing aerosol droplets to the process tube.

In one or more example drying systems, a liquid chamber of the mesh nebulizer receiving the solution of agent is connected with means to establish a pressure below ambient pressure in said chamber.

In one or more example drying systems, the aerosol generating device is configured to generate aerosol droplets in the size range of 1-50 μm.

In one or more example drying systems, the membrane sleeve is a thin sheet admitting diffusion of the solvent from process flow to the ascending flow, preferably said membrane has a controlled solvent sorbing capacity; more preferably said sheet comprises one or more of: paper, such as including rice paper, other polymer membranes with hydrophilic or hydrophobic surfaces, e.g., modified cellulose, polyether sulfone, PES, and nylon.

The controlled solvent sorbing capacity can for example be a controlled solvent adsorption capacity and/or a controlled solvent absorption capacity.

In one or more example drying systems, the drying system is provided with means configured to supply a gas flow to the tube reactor from a gas drying column, said means comprising an inlet flow rate measuring device located between said process tube and said gas drying column. The means to supply a gas flow when re-circulating the ascending gas flow and using the gas drying column may for example comprise a pump and/or a fan for re-circulating the gas.

The gas distribution column may for example be seen as a gas supply tank and/or a gas source. The gas distribution column may for example distribute the inlet gas to the process flow gas inlet, the ascending gas flow inlet, and/or the container/glovebox gas inlet.

In one or more example drying systems, the drying system comprises a first gas inlet for the process flow arranged at a top portion of the process tube. In one or more example drying systems, the first gas inlet is configured to introduce inlet gas to the perforated process tube for provision of a laminar process flow comprising descending aerosol droplets. In one or more examples or embodiments, a first gas outlet for the process flow is arranged at a bottom portion of the process tube.

In one or more example drying systems, the first gas inlet is generally annular in cross-section, thereby surrounding the aerosol generator device opening, and is provided with a plurality of outlet orifices arranged along a peripheral area of said first gas inlet in order to generate a process flow for transporting and directing the aerosol droplets towards a radial center of the process tube.

In some examples, the aerosol generator device opening can be seen as a nebulizer opening.

In one or more example drying systems, the drying system is characterized in that the orifices are angled and arranged with outlet channels having a major axis offset to a cross-sectional radius of the first gas inlet.

In one or more example drying systems, the drying system comprises a first vacuum source connected to one or more of: the outlet of the process flow, the outlet of the ascending gas flow, and the outlet of the container/glovebox, such as to contribute generating the process flow. The first vacuum source and/or the second vacuum source may for example comprise a vacuum pump and/or a central vacuum source system.

In one or more example drying systems, the drying system is characterized in that the ascending gas flow is a turbulent or laminar flow with a higher flow rate than the descending process flow.

In one or more example drying systems, the drying system comprises a second gas inlet for the ascending gas flow arranged tangentially to the tube reactor so that the second gas inlet is configured to introduce inlet gas such that the ascending gas flow performs a swirling motion around the membrane sleeve. In other words, the second gas inlet for the ascending gas flow may be arranged tangentially to the tube reactor at a bottom end side portion of the tube reactor. It may be appreciated that the swirling motion may increase a contact time of the ascending gas flow, such as drying gas, with the membrane surface. Furthermore, the swirling motion may provide a higher velocity of gas flow which may provide a rip-off effect of the solvent on the membrane surface, e.g., producing droplets of solvent that may be removed by the drying flow.

In one or more example drying systems, the drying system is characterized in that the tube reactor has a tangential inlet for the ascending gas flow.

In one or more example drying systems, the drying system comprises a second vacuum source connected to one or more of: the outlet of the process flow, the outlet of the ascending gas flow, and the outlet of the container/glovebox, e.g., to contribute generating the ascending gas flow. The first vacuum source and the second vacuum source may be different vacuum sources or the same central vacuum source.

In one or more example drying systems, the drying system comprises a second gas outlet for the ascending gas flow arranged tangentially to the tube reactor. In other words, the second gas outlet for the ascending gas flow may be arranged tangentially to the tube reactor at a top end side portion of the tube reactor. It may be appreciated that the swirling motion may increase a contact time of the ascending gas flow, such as drying gas, with the membrane surface. Furthermore, the swirling motion may provide a higher velocity of gas flow which may provide a rip-off effect of the solvent on the membrane surface, e.g., producing droplets of solvent that may be removed by the drying flow.

In one or more example drying systems, the flow rate of the ascending gas flow is substantially higher than the descending process flow.

In one or more example drying systems, the ascending gas flow has a flow rate from about ten to one hundred and fifty times the value of the descending process flow rate to about an equal flow rate value of the descending process flow rate.

In one or more example drying systems, the drying system is a spray drying system.

In one or more example drying systems, the drying system comprises a mesh arranged at the bottom end of the process tube for supporting the particle collecting device. For example, the mesh may be configured to support a filter as disclosed herein. In other words, the filter and/or the mesh may act as the particle collecting device as disclosed herein. The mesh and the filter may be arranged above the container as disclosed herein in order to collect the dry particles before falling into the container. In other words, the mesh and the filter may be configured to catch the dry particles. The mesh may let the gas flow through the mesh while dry particles may be caught by the filter and/or mesh. In one or more examples or embodiments, the particle collecting device may comprise a cyclone for separating the dry particles from the process flow.

In one or more example drying systems, the drying system comprises a container arranged at the bottom end of the process tube for accumulating and/or storing the dry particles of the composition. It may be appreciated that the dry particle collector as disclosed herein may comprise the container and vice versa. The container may comprise a collector cup for collecting the dry particles.

In one or more example drying systems, the drying system comprises a glovebox arranged at the bottom end of the tube reactor. In other words, the glovebox may comprise the particle collector device as disclosed herein, e.g., the particle collector device may be arranged in the glovebox.

In one or more example drying systems, the drying system comprises a third mass flow regulator configured to regulate an inlet gas flow of the glovebox.

In other words, the container may comprise a glovebox. The glovebox for example comprises the dry particle collector device.

In one or more example drying systems, the drying system comprises a third pressure sensor at an outlet gas flow of the glovebox and a sixth mass flow regulator configured to regulate the outlet gas flow of the glovebox. In one or more example drying systems, the third pressure sensor is configured to provide a third pressure signal. In one or more example drying systems, the sixth mass flow regulator is configured to regulate the outlet process flow based on the third pressure signal.

In one or more example drying systems, the glovebox comprises a fifth humidity sensor for monitoring humidity in the glovebox.

In one or more example drying systems, the drying system comprises a side-box arranged at the glovebox. In one or more example drying systems, an outlet hatch is arranged between the side-box and the glovebox for extracting a product.

A method of preparing a composition of dry particles from a solution of an agent using the drying system disclosed herein is disclosed. The method comprises providing a composition comprising a payload to an aerosol generating device. The method comprises generating a descending process flow in the form of a gas stream of aerosolized droplets in a tube reactor having an inner region and an outer region separated by a perforated process tube with an outer periphery covered by a membrane. The method comprises generating an ascending gas flow for counter-current removal of solvent from said process flow. The method comprises controlling the pressure of a tube reactor by regulating the ascending gas flow. The method comprises separating using the membrane said process flow and ascending gas flow, permitting diffusive transport of vaporized solvent through the membrane from said process flow to said ascending flow for drying the aerosol, such as drying the droplets in the process flow. The method comprises drying the droplets, while admitting vapor to diffuse through the membrane and into the ascending turbulent or laminar flow of dry gas at a rate that exceeds an opposite flow rate of dry gas radially through the membrane. The method comprises collecting a dry composition comprising the payload.

In one or more example methods, the method comprises monitoring mass transfer of solvent based on humidity and/or temperature measurements.

In one or more example methods, the method comprises providing energy into the tube reactor by heating the tube reactor from outside.

In one or more example methods, the method comprises sealingly transporting the solvent-rich ascended gas flow leaving the membrane to a solvent absorption column, transporting it through the column for solvent stripping and letting it re-contact the membrane for ascension through the reactor without generating a radial flow of gas through the membrane.

In one or more example methods, the method comprises tangentially introducing the ascending gas flow to the tube reactor in order to generate a swirling flow around the membrane.

In one or more example methods, the method comprises tangentially removing the ascended gas flow from the tube reactor.

In one or more example methods, the method comprises generating a rotating inlet gas flow to the process tube for centrally stabilizing the aerosol dispensed from the aerosol generating device.

In one or more example methods, the method comprises detecting and controlling the flow rate of the solvent stripped flow after the absorption column.

In one or more example methods, the method comprises monitoring the total mass balance of solvent in the drying system by balancing the disappearance of solvent from the nebulizer against the total outbound flux of solvent from the tube reactor.

In one or more example methods, the method comprises detecting the solvent concentration and flow rates in: the solvent-containing flow before the absorption column, and the effluent gas stream after the particle-collecting device.

In one or more example methods, the method comprises providing a liquid composition comprising a payload and at least one excipient. In one or more example methods, the method comprises nebulizing said composition into transportable droplets of less than 50 μm in the tube reactor. In one or more example methods, the method comprises drying the droplets, while admitting vapor to diffuse through the membrane and into the ascending turbulent or laminar flow of dry gas at a rate that exceeds an opposite flow rate of dry gas radially through the membrane. In one or more example methods, the method comprises collecting a dry composition comprising the payload and at the least one excipient.

The drying system as disclosed herein may be configured to perform any of the methods disclosed herein. It is to be understood that a description of a feature in relation to the drying system is also applicable to the corresponding feature in the method(s) of preparing a composition of dry particles as disclosed herein and vice versa.

Furthermore, the operations of the drying system may be considered a method that the drying system is configured to carry out. Also, while the described functions and operations may be implemented in software, such functionality may as well be carried out via dedicated hardware or firmware, or some combination of hardware, firmware and/or software.

The following figures and examples are provided below to illustrate the present invention. They are intended to be illustrative and are not to be construed as limiting in any way.

### BRIEF DESCRIPTION OF THE FIGURES

FIG. 1-2

Plot of the Drying flow absolute humidity (In the drying flow and the filter flow) vs Temperature of the heating element (Temperature ° C.) and Spray rate

FIG. 3-6

Plot of the Temperature inside the column vs Temperature of the heating element (Temperature ° C.) and Spray rate (ul/min).

FIG. 7

Working principle of LaminarPace Pilot-Scale Unit

FIG. 8

Process flows, control equipment and measuring points.

FIG. 9

Initial Multiphysics analysis; graphically interpreted overview of main transfer mechanisms of the Laminar Pace process, Part 1—H₂O-transport-landscape.

FIG. 10

Initial Multiphysics analysis; graphically interpreted overview of main transfer mechanisms of the Laminar Pace process, Part 2—N₂-transport-landscape.

FIG. 11

Initial Multiphysics analysis; graphically interpreted overview of main transfer mechanisms of the Laminar Pace process, Part 3—thermal energy-transport-landscape.

FIG. 12

Initial Multiphysics analysis; graphically interpreted overview of main transfer mechanisms of the Laminar Pace process, Part 4—mass-transport-landscape

FIG. 13

Absolute humidity (g/s) in the drying flow and Inner flow during the drying process with condition 1:1 L/min for drying flow; 60 L/min of the drying flow; 105 μ/min of spray rate and 25° C. as temperature of the heating element. Condition 2:1 L/min for drying flow; 60 L/min of the drying flow; 105 μ/min of spray rate and 50° C. as temperature of the heating element.

FIG. 14

Temperature inside the column for two different conditions using a sensor placed close to the nebulizer. Condition 1:1 L/min for drying flow; 60 L/min of the drying flow; 105 ul/min of spray rate and 25° C. as temperature of the heating element. Condition 2:1 L/min for drying flow; 60 L/min of the drying flow; 105 ul/min of spray rate and 50° C. as temperature of the heating element.

FIG. 15 shows a process flow diagram of an example drying system according to the present disclosure, where a technique as disclosed herein is applied.

FIG. 16 shows a perspective view of an example drying system according to the present disclosure.

FIG. 17 shows a perspective view of an example drying system according to the present disclosure.

FIG. 18A shows a side view of an example drying system according to the present disclosure.

FIG. 18B shows a side view of an example drying system according to the present disclosure.

FIG. 19 shows a front view of an example drying system according to the present disclosure.

FIG. 20 shows an exploded view of a portion of an example drying system according to the present disclosure.

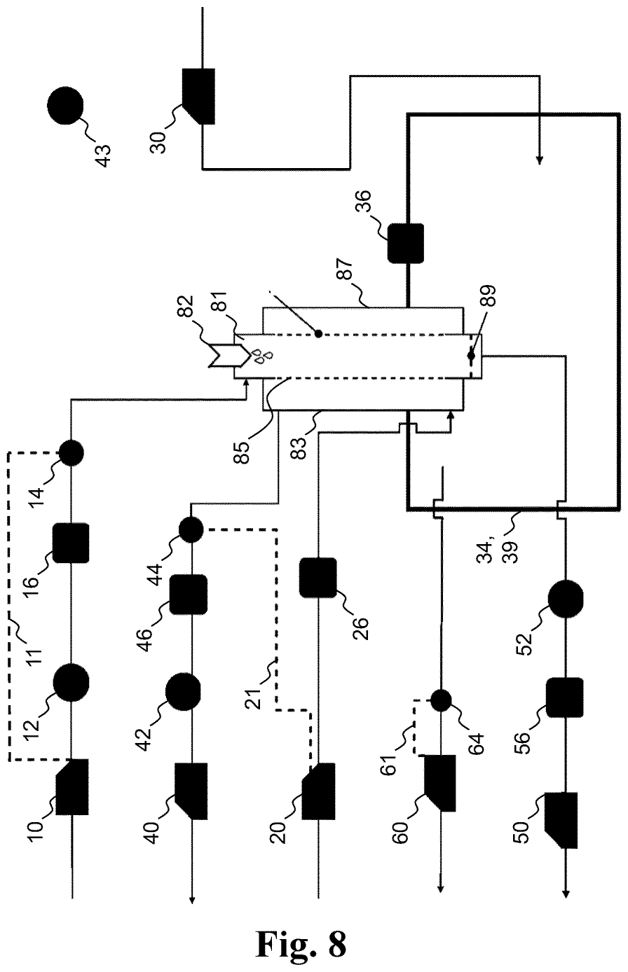

FIG. 8 shows a process flow diagram of an example drying system, such as drying system 1, according to the present disclosure, where a technique as disclosed herein is applied. In one or more examples or embodiments, the drying system 1 comprises an environment pressure sensor 43 for measuring an atmospheric pressure of the surroundings.

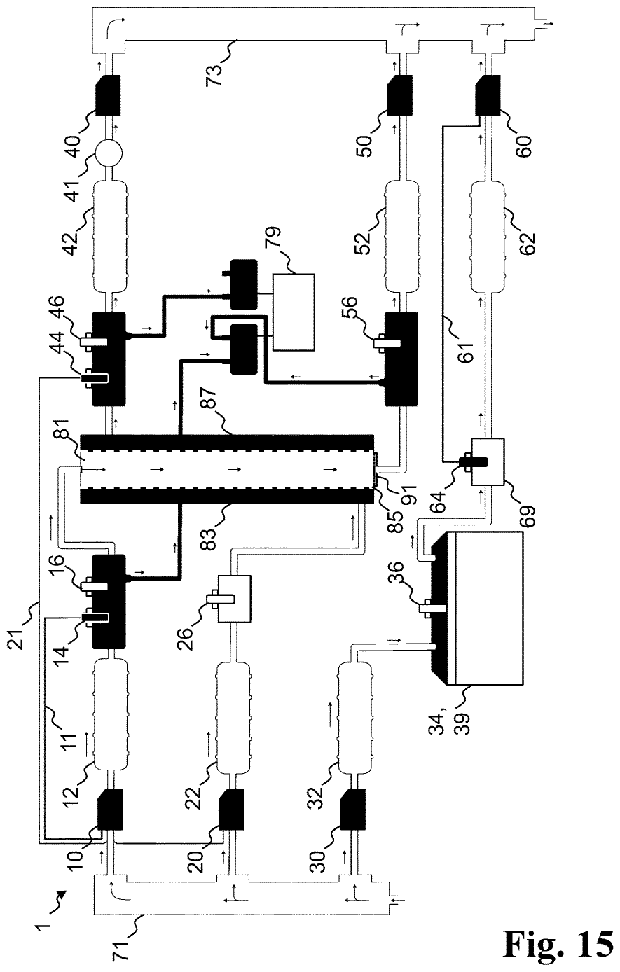

It may be appreciated that the description relating to FIG. 15 also applies to the description of FIG. 8.

FIG. 15 shows a process flow diagram of an example drying system, such as drying system 1, according to the present disclosure, where a technique as disclosed herein is applied.

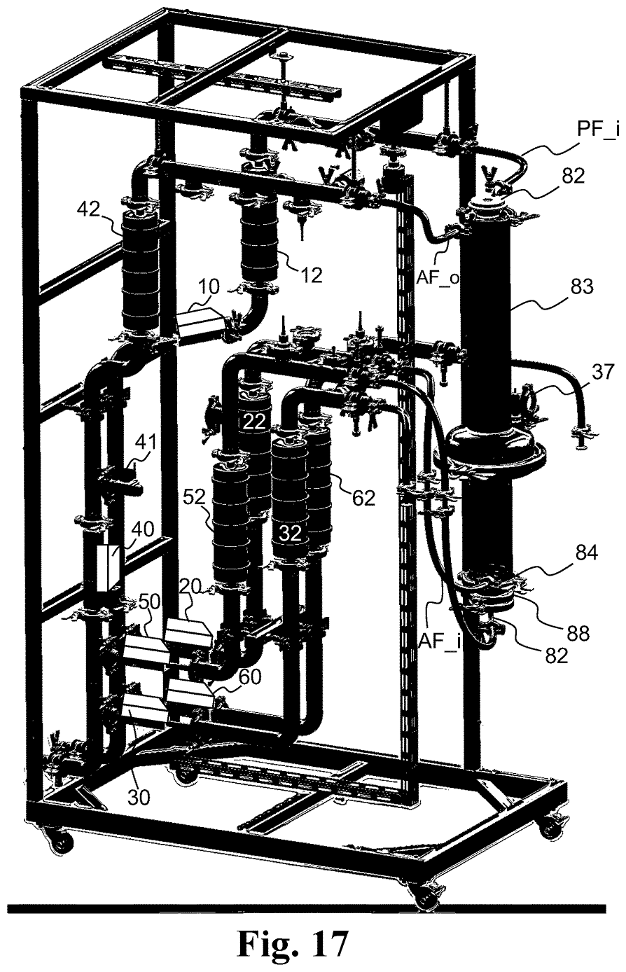

The drying system 1 may be configured to provide a composition of dry particles from a composition comprising a payload, such as a biopharmaceutical, comprising a generally cylindrical tube reactor 87 configured for counter-current removal of solvent from a process flow fed with aerosol droplets of solution descending from the top said reactor 87 with an ascending gas flow. The tube reactor 87 comprises a perforated process tube 81 for transportation of the process flow from an outlet of an aerosol generating device (such as aerosol generating device 82 disclosed herein), capable of generating said aerosol droplets of solution, to a dry particle collecting device 39. The tube reactor 87 comprises a membrane sleeve 85 essentially surrounding the peripheral area of said process tube 81. The membrane sleeve 85 is configured to separate the descending process flow from the ascending gas flow while admitting diffusion of vaporized solvent from the process flow to the ascending gas flow. The tube reactor 87 comprises a reactor housing 83 sealingly covering said process tube 81 and membrane sleeve 85. The tube reactor 87 may be provided with means for introducing and/or removing process fluids. For example, the tube reactor 87 comprises two or more gas inlets, e.g., for the gas inlet of the process flow (see PF_i in FIG. 17) and the gas inlet of the ascending gas flow, and two or more gas outlets, e.g., for the gas outlet of the process flow and the gas outlet of the ascending gas flow. The drying system 1 comprises a first mass flow regulator 20 configured to regulate the ascending gas flow. The first mass flow regulator 20 is configured to control the pressure in the tube reactor 87 by regulating the ascending gas flow.

In one or more example drying systems, the drying system 1 comprises a first pressure sensor 44 at an outlet of the ascending gas flow. In one or more example drying systems, the first pressure sensor 44 is configured to provide a first pressure signal 21 to the first mass flow regulator 20. In one or more example drying systems, the first mass flow regulator 20 is configured to control the pressure in the tube reactor 87 by regulating the ascending gas flow based on the first pressure signal 21.

The drying system 1 for example comprises the first pressure sensor 44 after the outlet of the ascending gas flow from the tube reactor 87.

In one or more example drying systems, the drying system 1 comprises a second mass flow regulator 10 configured to regulate the process flow.

In one or more example drying systems, the drying system 1 comprises a second pressure sensor 14 at an inlet of the process flow. In one or more example drying systems, the second pressure sensor 14 is configured to provide a second pressure signal 11. In one or more example drying systems, the second mass flow regulator 10 is configured to regulate the process flow based on the second pressure signal 11.

The drying system 1 for example comprises the second pressure sensor 14 before the inlet of the process flow, e.g., before an inlet of the inlet flow.

In one or more example drying systems, the drying system comprises one or more static pressure sensors 79 configured to measure a pressure difference between the outlet of the ascending gas flow, the inlet of the process flow, and the outlet of the process flow.

In one or more example drying systems, the drying system 1 comprises a first humidity sensor 46 at an outlet of the ascending gas flow and a third humidity sensor 26 at an inlet of the ascending gas flow. In one or more example drying systems, the first humidity sensor 46 is configured to provide a first humidity signal and the third humidity sensor 26 is configured to provide a third humidity signal. In one or more example drying systems, the drying system 1 is configured to determine a humidity parameter of the outlet of the ascending gas flow based on the first humidity signal and/or the third humidity signal.

The drying system 1 is for example configured to determine a humidity parameter of the humidity parameter of inlet of ascending gas flow. For example, the drying system 1 may compare a humidity of the ascending gas flow at an inlet of the ascending gas flow and at an outlet of the ascending gas flow, e.g., to determine and/or monitor a mass transfer in the tube reactor 87.

In one or more example drying system, the drying system 1 comprises a second humidity sensor 16 at an inlet of the process flow and a fourth humidity sensor 56 at an outlet of the process flow. In one or more example drying systems, the second humidity sensor 16 is configured to provide a second humidity signal. In one or more example drying systems, the fourth humidity sensor 56 is configured to provide a fourth humidity signal. In one or more example drying systems, the drying system 1 is configured to determine a humidity parameter of the outlet of the process flow based on the second humidity signal and/or the fourth humidity signal.

In one or more example drying systems, the first humidity sensor 46, the second humidity sensor 16, the third humidity sensor 26, and/or the fourth humidity sensor 56 comprise a dew point sensor.

In one or more example drying systems, the first humidity sensor 46, the second humidity sensor 16, the third humidity sensor 26, and/or the fourth humidity sensor 46 comprise a first dew point sensor, second dew point sensor, a third dew point sensor, and a fourth dew point sensor respectively.

In one or more example drying systems, the drying system 1 comprises one or more temperature sensors configured to provide one or more temperature signals.

In one or more examples or embodiments, the tube reactor 87 comprises one or more temperature sensors and/or the dew point sensors comprising a temperature sensor.

In one or more example drying systems, the drying system 1 is configured to monitor mass transfer of solvent based on one or more of: the first humidity signal, the second humidity signal, the third humidity signal, the fourth humidity signal, the process flow, the ascending gas flow, and the one or more temperature signals.

In one or more example drying systems, the drying system 1 comprises a heat element (not shown) configured to provide energy into the tube reactor 87.

In one or more example drying systems, the heat element is configured to bring heat into the tube reactor 87 from the outside of the tube reactor 87. In other words, the heat element may be arranged at an outer surface of the tube reactor 87. For example, the heat element may comprise one or more resistance elements, such as one or more heating wires, encircling the outer surface of the tube reactor. Furthermore, the heat element may comprise an insulating cover for covering the one or more resistance elements, such as heating wires. The insulating cover may for example avoid temperature fluctuations in the tube reactor and ensure that the heat from the resistance elements, such as heating wires, is provided to the tube reactor and is not lost in the surrounding air. The insulating cover may allow an improved energy efficiency of the heating element and substantially constant temperature in the tube reactor.

The heat element is for example configured to bring heat into the tube reactor 87 from the outside of the tube reactor by heating up the tube reactor from outside and transferring the heat via the material of the tube reactor 87, such as via walls of the tube reactor.

In one or more example drying systems, the heat element is selected from the group consisting of one or more of: a mantel, a dry bath, a resistance element, an incubator, and an infrared heater.

In one or more example drying systems, the drying system 1 is configured to control mass transfer of solvent by controlling one or more of: the heat element, the process flow, the ascending gas flow, and a spray rate of the aerosol generating device.

The drying system 1 may for example control mass transfer of the solvent by monitoring the mass transfer and getting feedback on the mass transfer.

In one or more example drying systems, the drying system 1 is configured to determine a temperature inside the tube reactor 87.

The drying system 1 may be configured to determine the temperature inside the tube reactor 87 based on one or more of: the one or more temperature outputs, and the one or more humidity outputs. The heat element is for example controlled based on a signal from the temperature sensor.

In one or more example drying systems, the aerosol generating device (such as aerosol generating device 82 as disclosed herein) located at the top of the tube reactor 87 is a downward acting mesh nebulizer, provided with an opening in its bottom part for dispensing aerosol droplets to the process tube 81.

In one or more example drying systems, a liquid chamber of the mesh nebulizer receiving the solution of agent is connected with means to establish a pressure below ambient pressure in said chamber.

In one or more example drying systems, the aerosol generating device (such as aerosol generating device 82 as disclosed herein) is configured to generate aerosol droplets in the size range of 1-50 μm.

In one or more example drying systems, the membrane sleeve 85 is a thin sheet admitting diffusion of the solvent from process flow to the ascending flow, preferably said membrane 85 has a controlled solvent sorbing capacity; more preferably said sheet comprises one or more of: paper, such as including rice paper, other polymer membranes with hydrophilic or hydrophobic surfaces, e.g., modified cellulose, polyether sulfone, PES, and nylon.

The stabilized solvent sorbing capacity can for example be a controlled solvent adsorption capacity and/or a controlled solvent absorption capacity.

In one or more example drying systems, the drying system 1 is provided with means configured to supply a gas flow to the tube reactor 87 from a gas distribution column 71, said means comprising an inlet flow rate measuring device located between said process tube 81 and said gas distribution column 71.

The gas distribution column 71 may for example be seen as a gas supply tank and/or a gas source. The gas distribution column 71 may for example distribute the inlet gas to the process flow gas inlet, the ascending gas flow inlet, and/or the container/glovebox gas inlet.

In one or more example drying systems, the drying system 1 comprises a first gas inlet for the process flow arranged at a top portion of the process tube 81. In one or more example drying systems, the first gas inlet is configured to introduce inlet gas to the perforated process tube 81 for provision of a laminar process flow comprising descending aerosol droplets.

In one or more example drying systems, the first gas inlet is generally annular in cross-section, thereby surrounding the aerosol generator device opening, and is provided with a plurality of outlet orifices arranged along a peripheral area of said first gas inlet in order to generate a process flow for transporting and directing the aerosol droplets towards a radial center of the process tube 81.

In some examples, the aerosol generator device opening can be seen as a nebulizer opening.

In one or more example drying systems, the drying system 1 is characterized in that the orifices are angled and arranged with outlet channels having a major axis offset to a cross-sectional radius of the first gas inlet.

In one or more example drying systems, the drying system 1 comprises a first vacuum source connected to one or more of: the outlet of the process flow, the outlet of the ascending gas flow, and the outlet of the container/glovebox, e.g., to contribute generating the process flow. The first vacuum source may for example be connected via the outlet column 73.

In one or more example drying systems, the drying system 1 is characterized in that the ascending gas flow is a turbulent or laminar flow with a higher flow rate than the descending process flow.

In one or more example drying systems, the drying system 1 comprises a second gas inlet for the ascending gas flow arranged tangentially to the tube reactor so that the second gas inlet is configured to introduce inlet gas such that the ascending gas flow performs a swirling motion around the membrane sleeve 85.

In one or more example drying systems, the drying system 1 is characterized in that the tube reactor 87 has a tangential inlet for the ascending gas flow.

In one or more example drying systems, the drying system 1 comprises a second vacuum source connected to one or more of: the outlet of the process flow, the outlet of the ascending gas flow, and the outlet of the container/glovebox, e.g., to contribute generating the ascending gas flow. The second vacuum source may for example be connected via the outlet column 73.

In one or more example drying systems, the drying system 1 comprises a second gas outlet for the ascending gas flow arranged tangentially to the tube reactor 87.

In one or more example drying systems, the flow rate of the ascending gas flow is substantially higher than the descending process flow.

In one or more example drying systems, the ascending gas flow has a flow rate from about ten to one hundred and fifty times the value of the descending process flow rate to about an equal flow rate value of the descending process flow rate.

In one or more example drying systems, the drying system 1 is a spray drying system.

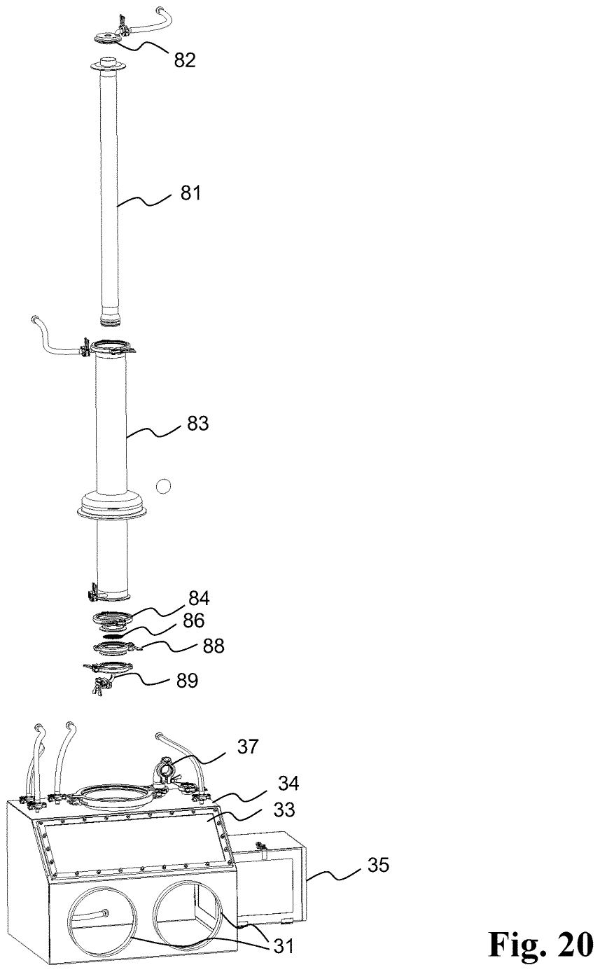

In one or more example drying systems, the drying system 1 comprises a mesh (such as mesh 86 of FIG. 20) arranged at the bottom end 91 of the process tube for supporting the particle collecting device. For example, the mesh may be configured to support a filter as disclosed herein. In other words, the filter and/or the mesh may act as the particle collecting device as disclosed herein. The mesh and the filter may be arranged above the container as disclosed herein in order to collect the dry particles before falling into the container. In other words, the mesh and the filter may be configured to catch the dry particles. The mesh may let the gas flow through the mesh while dry particles may be caught by the filter and/or mesh. In one or more examples or embodiments, the particle collecting device may comprise a cyclone for separating the dry particles from the process flow.

In one or more example drying systems, the drying system 1 comprises a container or particle collecting device 39 arranged at the bottom end of the process tube 81 for accumulating and/or storing the dry particles of the composition.

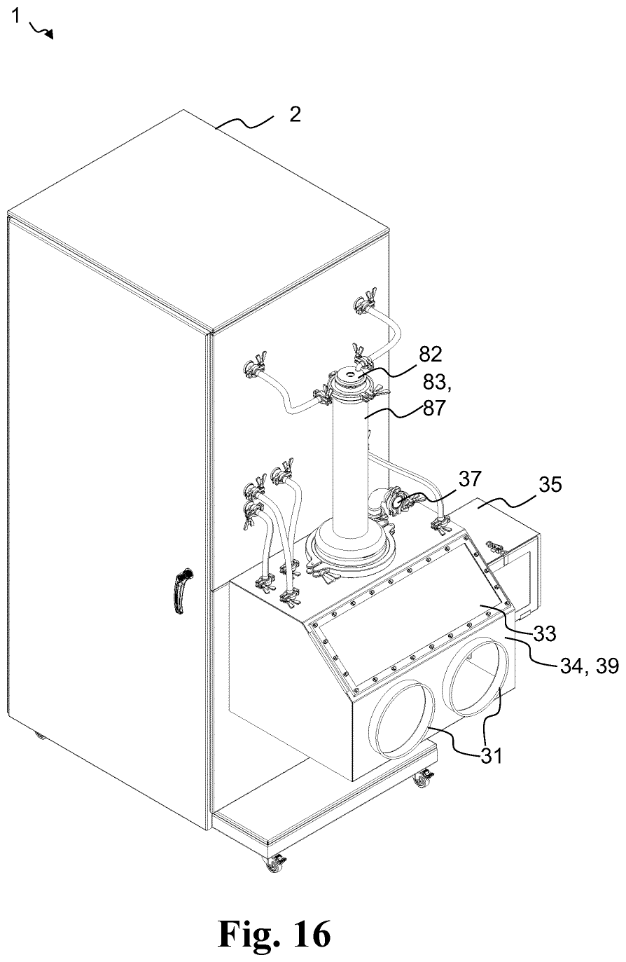

In one or more example drying systems, the drying system 1 comprises a glovebox 34 arranged at the bottom end 91 of the tube reactor 87. In one or more examples or embodiments, at least a portion of the tube reactor 87 is arranged in the glovebox 34 or container 39 (see e.g., FIGS. 16, 17, 18A, 19, 20).

In one or more example drying systems, the drying system 1 comprises a third mass flow regulator 30 configured to regulate an inlet gas flow of the glovebox 34.

In other words, the container 39 may comprise a glovebox 34. The glovebox 34 for example comprises the dry particle collector device.

In one or more example drying systems, the drying system 1 comprises a third pressure sensor 64 at an outlet gas flow of the glovebox 34 and a sixth mass flow regulator 60 configured to regulate the outlet gas flow of the glovebox 34. In one or more example drying systems, the third pressure sensor 64 is configured to provide a third pressure signal 61. In one or more example drying systems, the sixth mass flow regulator 60 is configured to regulate the outlet process flow based on the third pressure signal 61.

In one or more example drying systems, the glovebox 34 and/or the container 39 comprise a fifth humidity sensor 36 for monitoring humidity in the glovebox 34 and/or the container 39.

In one or more example drying systems, the drying system 1 comprises a side-box (such as side-box 35 of FIGS. 16, 17, 18A, 19, 20) arranged at the glovebox 34. In one or more example drying systems, an outlet hatch is arranged between the side-box and the glovebox 34 for extracting a product (such as a dried composition).

In one or more example drying systems, the drying system 1 comprises a fourth mass flow regulator 40 configured to regulate the outlet gas flow of the ascending gas flow.

In one or more example drying systems, the drying system 1 comprises a fifth mass flow regulator 50 configured to regulate the outlet gas flow of the process flow.

In one or more example drying systems, the drying system 1 comprises an overpressure valve (such as overpressure valve 37 as disclosed herein). For example, the overpressure valve may be a safety overpressure valve in a scenario where the pressure, such as absolute pressure, is above a certain threshold. The overpressure valve 37 may for example comprise a burst disc in case the pressure is above a threshold.

In one or more examples or embodiments, the drying system 1 comprises a safety valve 41. The safety valve 41 may be arranged between the outlet of the ascending gas flow and the fourth mass flow regulator 40.

In one or more examples or embodiments, the drying system 1 comprises a first filter 22 for filtering inlet gas for the ascending gas flow. The first filter 22 may be arranged between the first mass flow regulator 20 and the inlet of the ascending gas flow.

In one or more examples or embodiments, the drying system 1 comprises a second filter 12 for filtering inlet gas for the process flow. The second filter 12 may be arranged between the second mass flow regulator 10 and the inlet of the process flow.

In one or more examples or embodiments, the drying system 1 comprises a third filter 32 for filtering inlet gas for the inlet gas flow of the glovebox 34. The third filter 32 may be arranged between the third mass flow regulator 30 and the inlet of the inlet gas flow of the glovebox 34.

In one or more examples or embodiments, the drying system 1 comprises a fourth filter 42 for filtering outlet gas from the ascending gas flow. The fourth filter 42 may be arranged between the outlet of the ascending gas flow and the fourth mass flow regulator 40.

In one or more examples or embodiments, the drying system 1 comprises an outlet column 73 for receiving the outlets from the ascending gas flow, the process flow, and/or the glovebox outlet flow. In one or more examples or embodiments, the outlet column 73 may be connected to a vacuum source, such as a vacuum pump or central vacuum system, for aspirating the outlet gases from the process flow outlet, the ascending gas flow outlet, and the glovebox/container gas flow outlet. The outlet column 73 may be seen as an outlet gas distribution column.

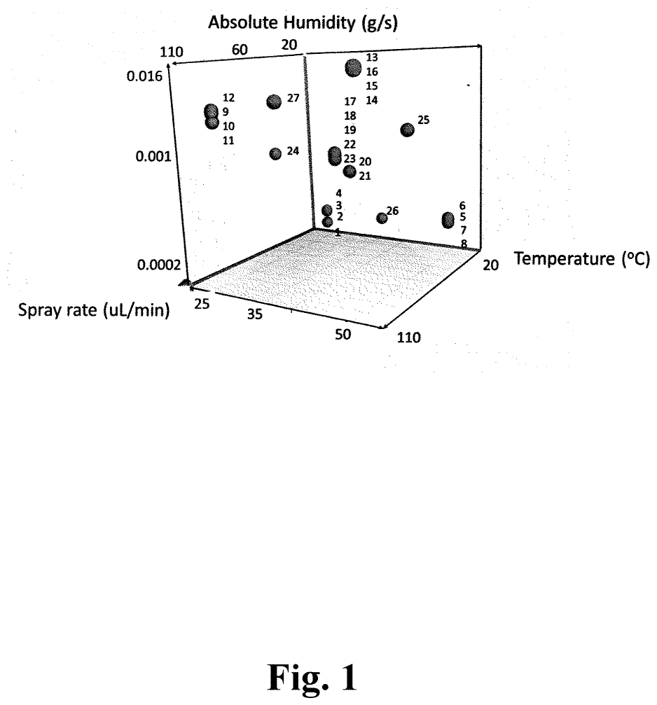

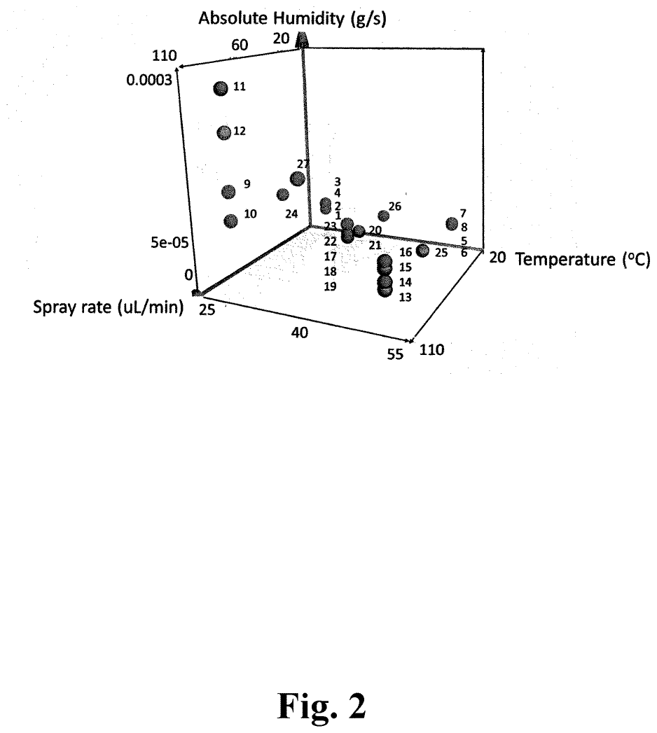

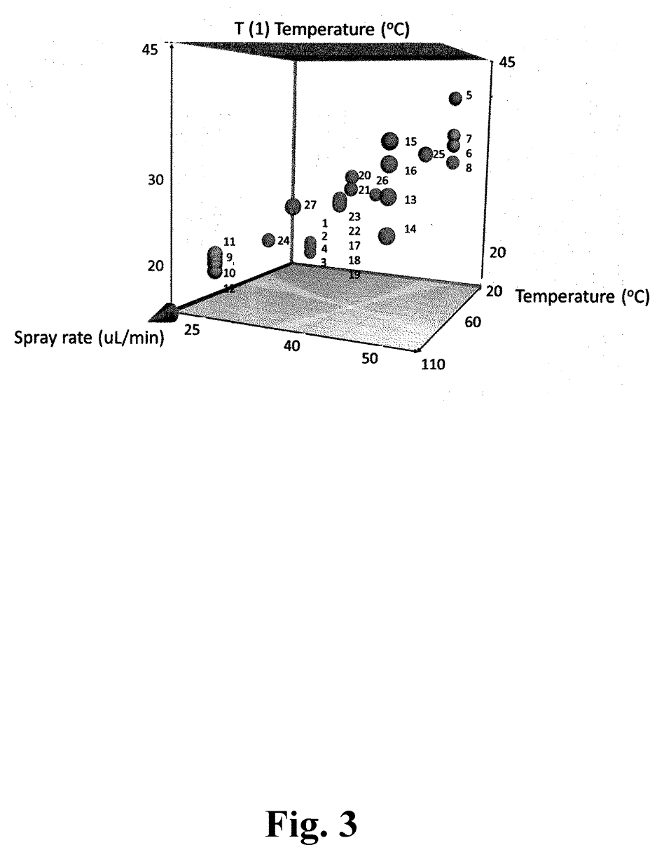

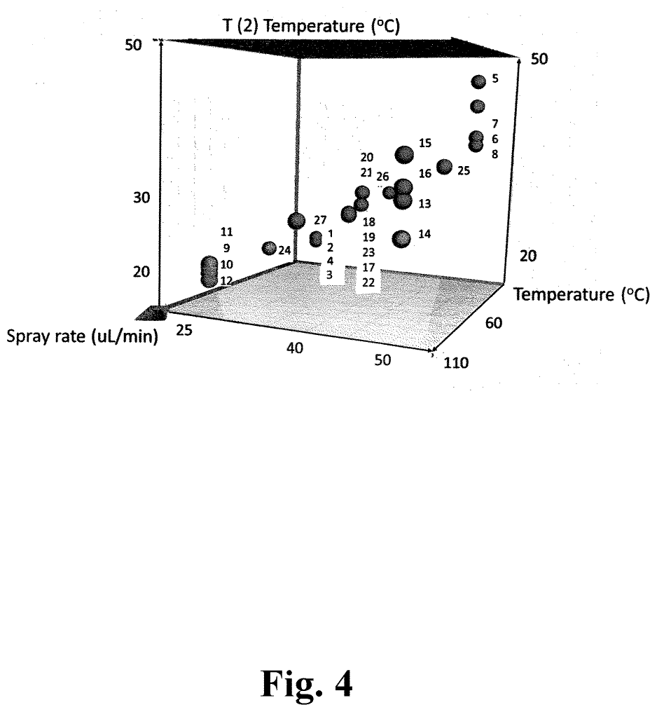

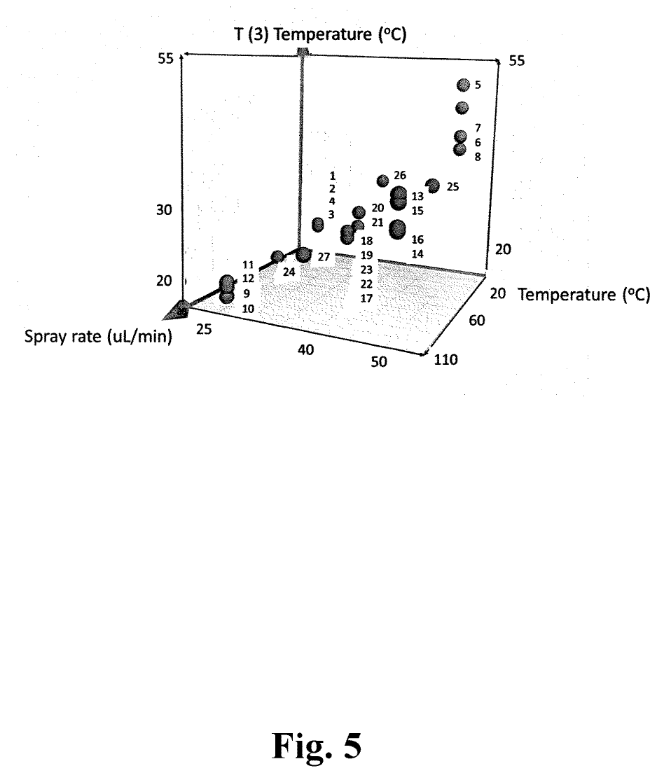

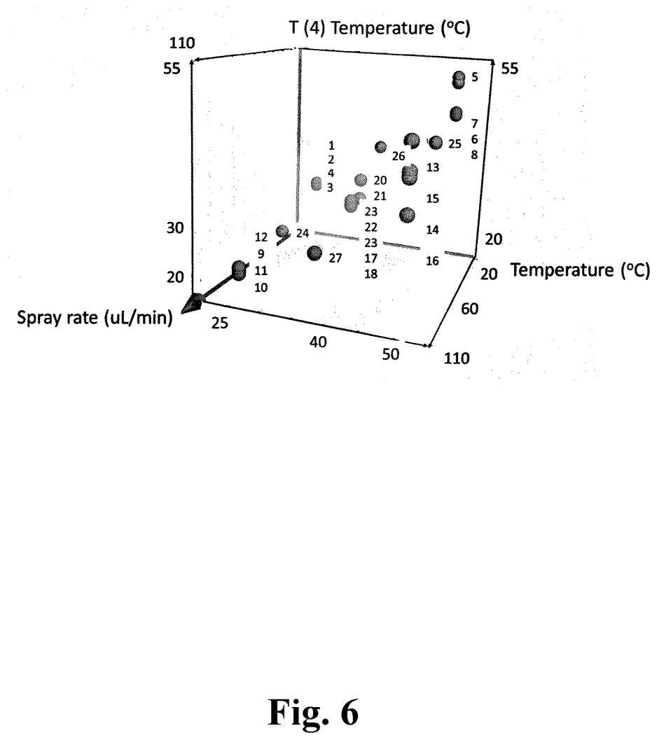

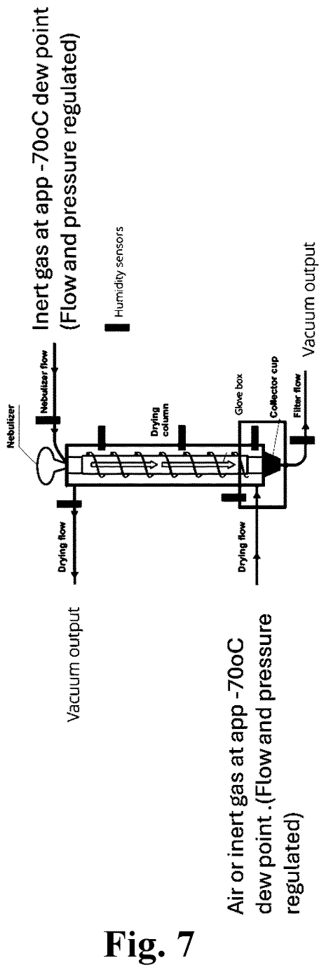

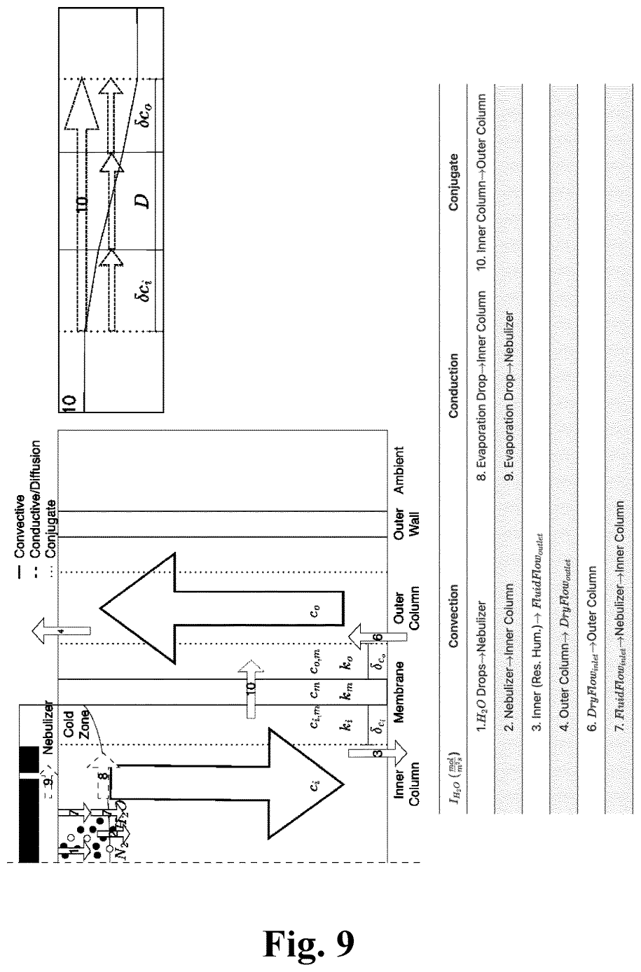

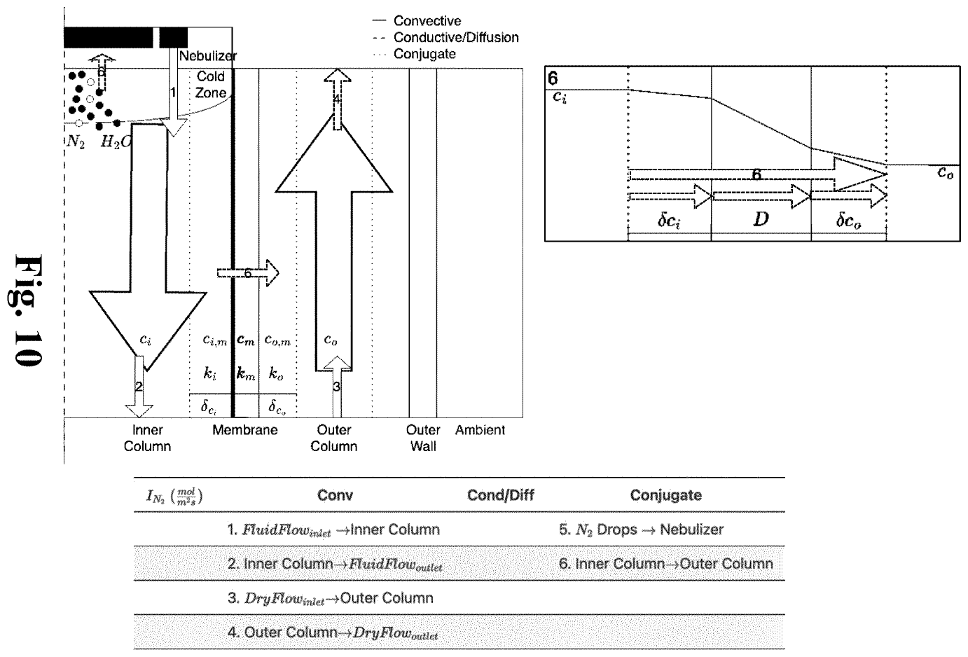

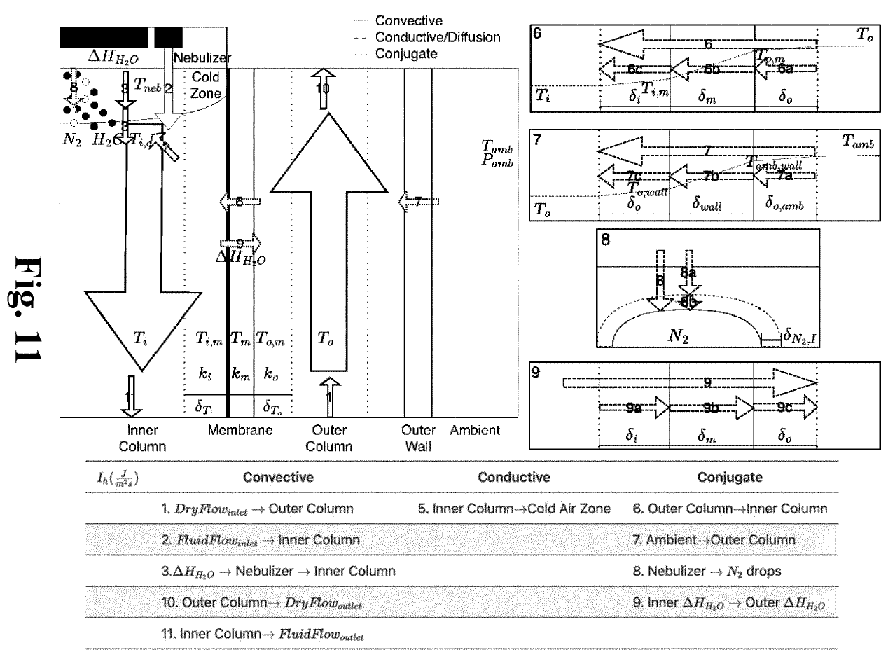

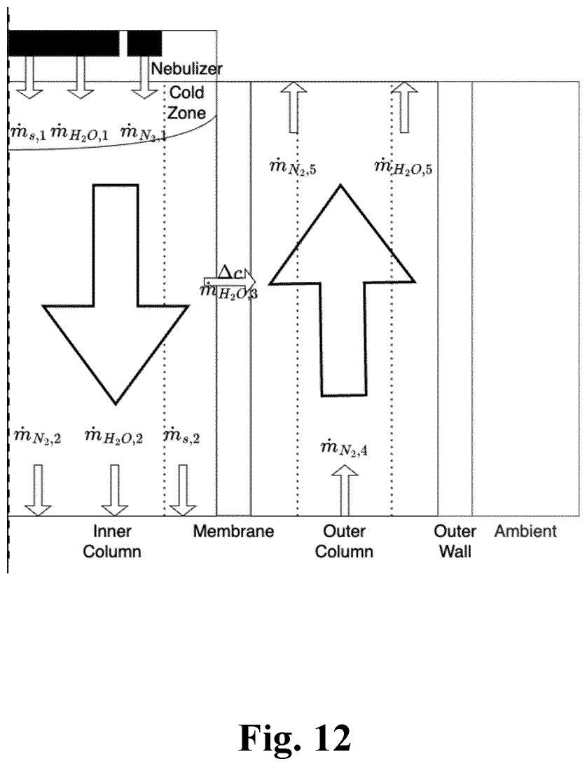

It may be appreciated that any of the definitions and terms used in the description of FIGS. 1-15 may also apply to the description of FIGS. 16, FIG. 17, FIGS. 18A-18B, FIG. 19, and FIG. 20 and vice versa. For example, any definitions, reference numbers, and terms associated with the drying system of FIG. 15 may also apply and/or be used to the definitions, reference numbers, and terms relating to the drying system of FIGS. 16-20 and vice versa.

FIG. 16 shows a perspective view of an example drying system according to the present disclosure. FIG. 16 shows a perspective view of a drying system 1, such as the drying system described in FIG. 15. As may be seen on FIG. 16-19, the drying system 1 may comprise a cabinet 2 for storing and/or hiding the mass flow regulators, filters, sensors, piping/tubing etc. The cabinet 2 may comprise a door for servicing the drying system. The cabinet 2 may comprise wheels such that the drying system is mobile. The front part of the drying system may be mounted on one side of the cabinet. The front side may comprise the tube reactor 87 connected to the different inlets and outlets with piping/tubing. Optionally, the front part may comprise a glovebox 34. When the drying system 1 does not have a glovebox, the drying system 1 may comprise a container 39, such as a container 39 comprising a particle collecting device.

In one or more example drying systems, the glovebox 34 is arranged at the bottom end of the tube reactor 87. In one or more examples or embodiments, at least a portion of the tube reactor 87 is arranged in the glovebox 34 or container 39 (see e.g., FIGS. 16, 17, 18A, 19, 20).

In one or more example drying systems, the drying system 1 comprises a side-box 35 arranged at the glovebox 34. In one or more example drying systems, an outlet hatch is arranged between the side-box and the glovebox 34 for extracting a product (such as a dried composition). The glovebox 34 may comprise an inspection window 33 to be able to inspect inside the glovebox, e.g., while manipulating the product inside the glovebox with the gloves.

The glovebox 34 comprises glove openings 31 for arranging gloves. The gloves may close the glove openings so that the glovebox is sealed from the surrounding environment. The glovebox 34 may allow to handle the dried particles (such as the output yield of the drying system), in a sealed airtight environment. The glovebox 34 may for example be continuously flushed with an inert gas (such as nitrogen) so that the product of dried particles is protected from contamination from the surrounding environment.

FIG. 17 shows a perspective view of an example drying system according to the present disclosure. FIG. 17 shows a perspective view of a drying system 1, such as the drying system described in FIG. 15 and shown in FIG. 16, but where the cabinet door is opened. As may be observed on FIG. 17, the first mass flow regulator 20, second mass flow regulator 10, third mass flow regulator 30, fourth mass flow regulator 40, fifth mass flow regulator 50, sixth mass flow regulator 60, the first filter 22, the second filter 12, the third filter 32, the fourth filter 42, and the safety valve 41 are arranged inside the cabinet 2. The components in the cabinet 2 are arranged such as to provide a compact drying system 1.

In one or more example drying systems, the drying system 1 comprises a second gas inlet AF_i (such as ascending gas flow inlet) for the ascending gas flow arranged tangentially to the tube reactor 87 so that the second gas inlet AF_i is configured to introduce inlet gas such that the ascending gas flow performs a swirling motion around the membrane sleeve.

In one or more example drying systems, the drying system 1 is characterized in that the tube reactor 87 has a tangential inlet AF_i for the ascending gas flow.

In one or more example drying systems, the drying system 1 comprises a second gas outlet AF_o (such as ascending gas flow outlet) for the ascending gas flow arranged tangentially to the tube reactor 87.

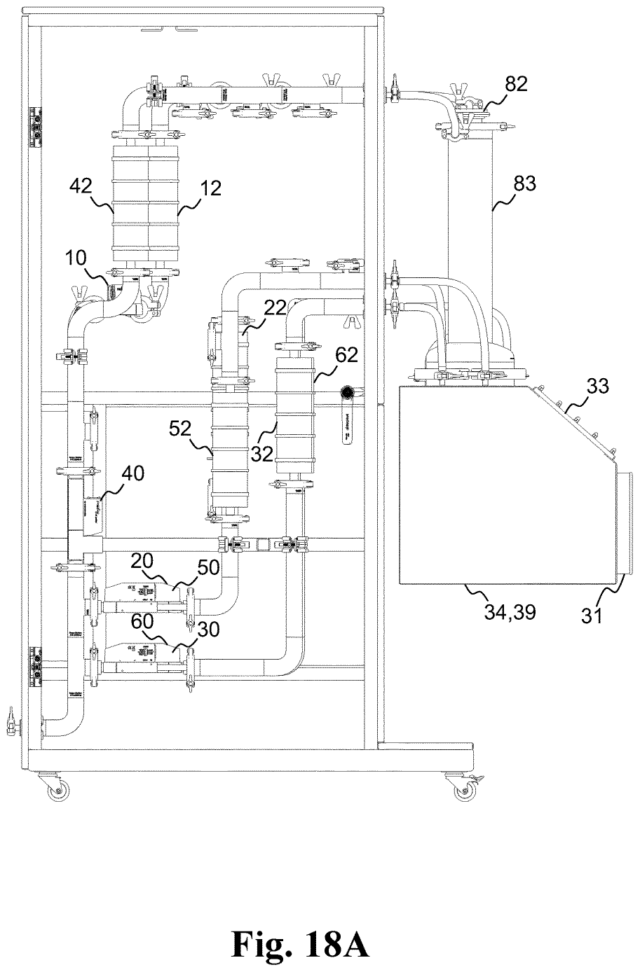

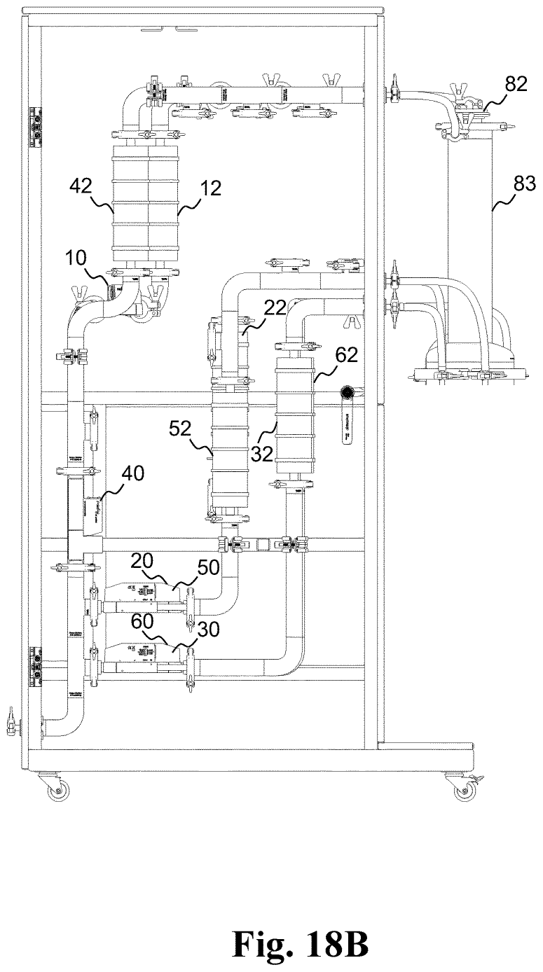

FIG. 18A shows a side view of an example drying system according to the present disclosure. FIG. 18A shows a side view of a drying system 1, such as the drying system described in FIG. 15 and shown in FIGS. 16-17.

FIG. 18B shows a side view of an example drying system according to the present disclosure. FIG. 18B shows a side view of a drying system 1, such as the drying system described in FIG. 15 and shown in FIGS. 16-17 but without the container or glovebox.

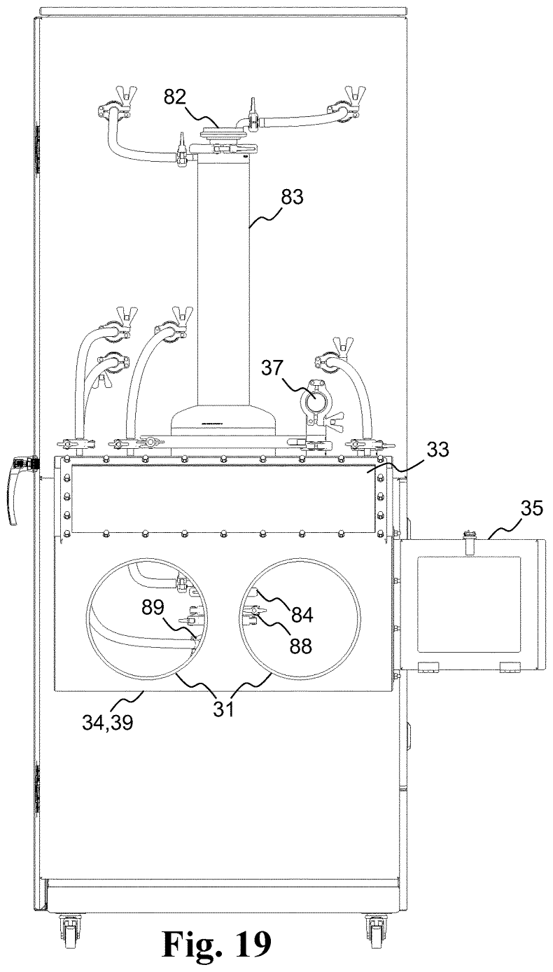

FIG. 19 shows a front view of an example drying system according to the present disclosure. FIG. 19 shows a front view of a drying system 1, such as the drying system described in FIG. 15 and shown in FIGS. 16-18A.

FIG. 20 shows an exploded view of a portion of an example drying system according to the present disclosure. FIG. 20 shows an exploded view of a portion of the drying system 1, such as the drying system described in FIG. 15 and shown in FIGS. 16-19. FIG. 20 shows an exploded view of the front as described in FIG. 16.

### EXAMPLES

### Example 1—Column Temperature Effect on the Mass Transfer and on the Temperature Drop Compensation

### Abbreviations:

LaPa: LaminarPace
DoE: Design of Experiments

### Introduction and Experiment Description:

The applicant has developed a pilot scale set-up of the Laminar Pace Ambient Nitrogen/Air Drying system (LaminarPace), a counter-current spray drying unit with separate flows operating at room temperature, which can produce limited quantities of dried, stabilized, micronized vaccine.

The present LaminarPace unit consists of a main part: The drying column where the drying process takes place, which contains an inner part: the inner column (about 90 cm long, 5 cm ID, made of steel), which is perforated and covered with a vapor permeable membrane (e.g. approximately 100 μm layer of filter membrane). The membrane creates the separation to an outer part where the counter-current flow circulates.

Atomization of the liquid into a spray of fine droplets is created with a vibrating mesh nebulizer. The droplets have a well-defined micronized size. A laminar flow (Nitrogen/Air) is generated inside the inner column to facilitate droplet movement and mass transfer to the membrane. The inner column flow is also used to control the residence time of the particles. In the outer column, a dry Nitrogen stream circulates counter-currently around the inner column and transports away the water vapor diffused through the membrane. At the end of the process, micronized dry powder with a narrowly dispersed size distribution and well-defined shape is collected on a filter paper at the bottom of the drying column. Several humidity sensors provide a good understanding of the humidity mass balance. At the current LaminarPace Pilot-scale stage and using the best condition of drying >98% of the absolute humidity is effectively transported through the membrane. A temperature mapping inside the inner column and during the drying process has shown that a drop of the temperature happens, the temperature could drop down to 14-17° C. This temperature drop is due to the evaporation process. To compensate the drop and to control the temperature of the process, a heating element was placed outside of the column, bringing heat from the outside of the column. This experiment shows the effect of this heating element temperature input on the temperature compensation but also on the humidity mass balance and on the LaPa drying unit capacity.

To be able to map the temperature inside the inner column, 4 sensors were placed at different distances (defined) from the nebulizer. The temperature of these sensors was recorded during the different runs.

For this experiment 4 parameters were assessed:
Heating element temperature input (Role of the temperature).
Spray rate (Role of the volume introduce into the LaPa drying, and so on the capacity).
Drying flow (Role of the counter-current nitrogen/air flow).
Inner (Nebulizer) flow (Role of the nitrogen/air flow into the inner column)

A separate experiment was performed using the same parameters in order to record the absolute humidity of the drying flow and filter flow (Inner flow after the column).

### Materials and Methods:

TABLE 1
Chemical and materials list

| | Description | Batch number/sample number |
|---|---|---|
| Nebulizer | Aerogen | 2301B/2303A |
| Nitrogen/Dry air | Dry air | N/A |
| Membrane | Rice paper | N/A |
| Liquid sample | PBS | N/A |
| LAPA system | B3.1 | N/A |

### Experimental Setup:

TABLE 2
Investigated parameters

| | | |
|---|---|---|
| Parameter | Min value | Max value |

| | | | | |
|---|---|---|---|---|
| Column temperature | 25° | C. | 50° | C. |
| Spray rate | 16 | μl/min | 100 | μl/min |
| Drying flow | 35 | l/min | 60 | l/min |
| Inner flow | 1 | l/min | 2.5 | l/min |

TABLE 3
Fixed parameters

| Parameter | Set value |
|---|---|
| Column pressure | 25 mBar |

TABLE 4
List of experiments

| | Drying Flow | Filter Flow | Temperature | Spray rate |
|---|---|---|---|---|
| Exp Name | (L/min) | (L/min) | (° C.) | (μl/min) |
| N1 | 35 | 1 | 25 | 16.865 |
| N2 | 60 | 1 | 25 | 16.865 |
| N3 | 35 | 2.5 | 25 | 16.865 |
| N4 | 60 | 2.5 | 25 | 16.865 |
| N5 | 35 | 1 | 50 | 16.865 |
| N6 | 60 | 1 | 50 | 16.865 |
| N7 | 35 | 2.5 | 50 | 16.865 |
| N8 | 60 | 2.5 | 50 | 16.865 |
| N9 | 35 | 1 | 25 | 101.438 |
| N10 | 60 | 1 | 25 | 101.438 |
| N11 | 35 | 2.5 | 25 | 101.438 |
| N12 | 60 | 2.5 | 25 | 101.438 |
| N13 | 35 | 1 | 50 | 101.438 |
| N14 | 60 | 1 | 50 | 101.438 |
| N15 | 35 | 2.5 | 50 | 101.438 |
| N16 | 60 | 2.5 | 50 | 101.438 |
| N17 | 47.5 | 1.8 | 37 | 59.1515 |
| N18 | 47.5 | 1.8 | 37 | 59.1515 |
| N19 | 47.5 | 1.8 | 37 | 59.1515 |
| N20 | 35 | 1.8 | 37 | 46.5 |
| N21 | 60 | 1.8 | 37 | 47.33 |
| N22 | 47.5 | 1 | 37 | 59.1515 |
| N23 | 47.5 | 2.5 | 37 | 59.1515 |
| N24 | 47.5 | 1.8 | 25 | 59.1515 |
| N25 | 47.5 | 1.8 | 50 | 59.1515 |
| N26 | 47.5 | 1.8 | 37 | 16.865 |
| N27 | 47.5 | 1.8 | 37 | 101.438 |

### Result Summary and Conclusions:

The results are sum-up in the table below:

TABLE 5

| | Drying Flow | Filter Flow | Humidity | T1 | T2 | T3 | T4 | | | | |
|---|---|---|---|---|---|---|---|---|---|---|---|
| Sample | Humidity | Humidity | left | drop | drop | drop | drop | T1 | T2 | T3 | T4 |
| name | (g/s) | (g/s) | (%) | (° C.) | (° C.) | (° C.) | (° C.) | (° C.) | (° C.) | (° C.) | (° C.) |
| N1 | 0.000123 | 1.5e−07 | 0.109064 | −6.35725 | −5.51052 | −3.6247 | −0.67743 | 19.0496 | 20.1742 | 21.9799 | 24.1009 |
| N2 | 0.000233 | 2.71e−07 | 0.0848694 | −6.35729 | −5.51086 | −3.62517 | −0.677881 | 19.0496 | 20.1742 | 21.9799 | 24.1009 |
| N3 | 0.000225 | 1.19e−05 | 4.53232 | −6.54314 | −5.08129 | −3.6808 | −1.75501 | 17.5864 | 19.6065 | 21.2757 | 23.3674 |
| N4 | 0.000224 | 1.11e−05 | 4.4877 | −5.66509 | −4.49354 | −3.32065 | −1.47799 | 18.5096 | 20.2408 | 21.6659 | 23.5743 |
| N5 | 0.000266 | 1e−25 | 1e−07 | −13.1634 | −8.36135 | −4.00585 | 2.453 | 39.9361 | 46.2533 | 50.7632 | 50.0744 |
| N6 | 0.000279 | 1e−25 | 1e−07 | −10.7664 | −8.47786 | −6.23525 | 0.251256 | 33.8362 | 37.8785 | 41.4748 | 43.6179 |
| N7 | 0.000264 | 3.1e−06 | 1.13553 | −9.47043 | −6.30176 | −4.97635 | −1.87978 | 35.1509 | 42.5828 | 46.6625 | 51.2582 |
| N8 | 0.00024 | 2.37e−06 | 0.958612 | −8.3176 | −6.51222 | −5.94152 | −2.51646 | 31.6267 | 36.687 | 39.1123 | 42.9998 |
| N9 | 0.00125 | 0.000115 | 7.23908 | −4.05842 | −4.91843 | −7.55629 | −9.24416 | 21.1351 | 20.7181 | 18.3689 | 16.2883 |
| N10 | 0.00124 | 6.93e−05 | 5.11435 | −4.39403 | −5.21332 | −8.22866 | −9.59827 | 20.5992 | 19.9561 | 16.8454 | 15.0255 |
| N11 | 0.00118 | 0.000268 | 17.22 | −3.70426 | −4.52051 | −6.70968 | −9.99757 | 21.6701 | 21.2366 | 19.2397 | 15.5599 |
| N12 | 0.00126 | 0.000204 | 13.4701 | −4.13379 | −5.32623 | −5.79551 | −8.21014 | 19.7091 | 19.044 | 18.7961 | 16.3022 |
| N13 | 0.00153 | 2.03e−06 | 0.112739 | −19.5828 | −18.7793 | −12.2251 | 2.61902 | 29.6316 | 31.3967 | 36.3388 | 44.0321 |
| N14 | 0.00152 | 1.31e−05 | 0.524743 | −17.8077 | −17.3157 | −11.8288 | 0.172217 | 25.6596 | 26.8415 | 31.0574 | 37.8352 |
| N15 | 0.00152 | 4.27e−05 | 2.63818 | −11.727 | −14.3431 | −17.4885 | −14.2603 | 35.2039 | 36.7354 | 35.2734 | 38.838 |
| N16 | 0.00153 | 3.32e−05 | 1.74579 | −11.8702 | −14.4563 | −17.4804 | −14.2838 | 32.9156 | 32.9528 | 31.5367 | 31.2201 |
| N17 | 0.000884 | 1.09e−05 | 1.03205 | −8.50879 | −8.94551 | −11.0325 | −8.33019 | 26.9222 | 26.8333 | 25.411 | 25.7434 |
| N18 | 0.000877 | 1.02e−05 | 0.975869 | −6.80621 | −8.10181 | −10.8417 | −9.79849 | 27.2391 | 27.0916 | 25.548 | 25.4342 |
| N19 | 0.000869 | 9.72e−06 | 0.930541 | −6.90816 | −8.32579 | −10.9756 | −9.74445 | 27.2049 | 26.9208 | 25.5152 | 25.7127 |
| N20 | 0.000704271 | 4.76413e−06 | 0.0052373 | −6.59778 | −8.40344 | −11.3654 | −8.90632 | 29.7629 | 29.597 | 27.927 | 29.6054 |
| N21 | 0.000710902 | 6.09082e−06 | 0.00661916 | −5.44299 | −7.55974 | −10.2588 | −8.32032 | 28.2318 | 27.8293 | 25.4351 | 25.6686 |
| N22 | 0.000835278 | 1.51251e−05 | 0.0108467 | −7.84835 | −9.13102 | −12.5355 | −8.93746 | 27.3221 | 26.7654 | 24.4152 | 26.0939 |
| N23 | 0.000874811 | 3.22638e−05 | 0.0295429 | −6.96755 | −8.16416 | −10.4281 | −9.073 | 26.6252 | 26.8352 | 25.4439 | 26.5546 |
| N24 | 0.000849 | 6.97733e−05 | 6.51062 | −3.55919 | −4.49268 | −6.42541 | −7.62416 | 21.2938 | 20.8085 | 19.1097 | 17.6761 |
| N25 | 0.00107 | 5.17589e−06 | 0.367882 | −12.6121 | −13.9916 | −15.4417 | −8.26756 | 33.2915 | 34.3811 | 34.9637 | 40.3576 |
| N26 | 0.000215353 | 5.60034e−07 | 0.00222799 | −7.54284 | −6.75319 | −4.50037 | −1.06196 | 26.6453 | 28.5736 | 31.8928 | 34.2445 |
| N27 | 0.00132361 | 0.000146612 | 0.0885045 | −6.31697 | −7.53994 | −11.0419 | −13.5491 | 27.8151 | 27.8949 | 25.5654 | 21.6551 |

### Results Summary and Conclusions:

The results (see tables and FIGS. 1-6) show the positive effect on the drying capacity (mass transfer) and on the temperature control inside the column when a heating element is used to bring heat from the outside of the column.

The results show that by compensating the drop of temperature due to evaporation, the mass transfer efficiency from the inner column to the outer column can be increased up to 22%.

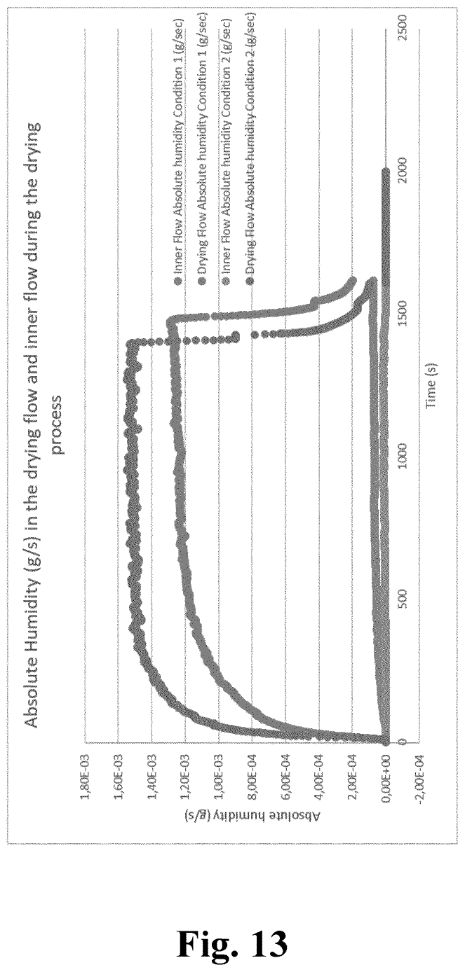

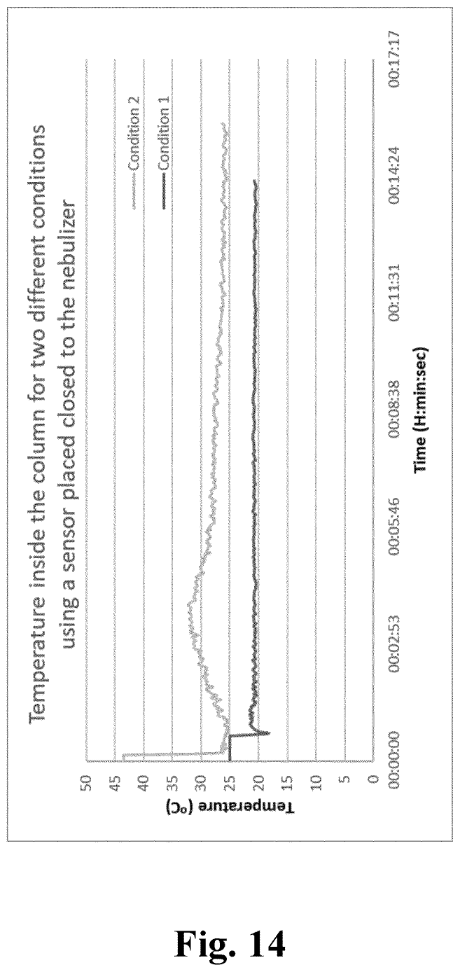

The increase of the mass transfer efficiency can be seen by the increase of the drying capacity of the LaPa drying unit. The spray rate can be increased from 30 ul/min up to 100 ul/min while keeping the room temperature condition and the low humidity left (less than 2%). FIGS. 13-14 show absolute humidity (g/s) in the drying flow and Inner flow during the drying process and temperature inside the column for two different conditions using a sensor placed closed to the nebulizer at two conditions.

Examples of drying systems, and methods according to the disclosure are set out in the following items:

Item A1. A drying system adapted to provide a composition of dry particles from a composition comprising a payload, such as a biopharmaceutical, comprising a generally vertical tube reactor arranged for counter-current removal of solvent from a process flow fed with aerosol droplets of solution descending from the top said reactor with an ascending gas flow, characterized in that the tube rector comprises:
(i) a perforated process tube for transportation of the process flow from the outlet of an aerosol generating device, capable of generating said aerosol droplets of solution, to a dry particle collecting device;
(ii) a membrane sleeve essentially surrounding the peripheral area of said process tube, separating the descending process flow from the ascending gas flow while admitting diffusion of vaporized solvent from the process flow to the ascending gas flow;
(iii) a reactor housing sealingly covering said process tube and membrane sleeve being provided with means for introducing and/or removing the process fluids, and wherein the system comprises an element that can introduce energy, such as heat or infrared, into the vertical tube reactor.

Item A2. The drying system according to item 1, which is a spray drying system.

Item A3. The drying system according to any of the previous items, wherein the heat element is used to bring heat into the vertical tube reactor from the outside of the vertical tube reactor.

Item A4. The drying system according to any of the previous items, wherein the heat element is selected from the group consisting of a mantel, heat element, dry bath, incubator and infrared heater.

Item A5. The drying system according to any of the previous items, wherein the vertical tube reactor comprises means for monitoring the temperature inside the vertical tube reactor.

Item A6. The drying system according to any of the previous items, wherein one or more the vertical tube reactor comprises one or more temperature sensors.

Item A7. The drying system according to any of the previous items, wherein the system comprises means for adjusting the temperature inside the vertical tube reactor.

Item A8. The drying system according to any of the previous items, wherein the system comprises means for monitoring mass transfer.

Item A9. The drying system according to any of the previous items, wherein the system comprises means for controlling mass transfer.

Item A10. The drying system according to any of the previous items, wherein the system comprises means for controlling introducing energy into the column.

Item A11. The drying system according to any of the previous items, wherein the system comprises means for controlling energy and mass transfer.

Item A12. The drying system according to any of the previous items, wherein the aerosol generating device located at the top of the tube reactor is a downward acting mesh nebulizer, provided with an opening in its bottom part for dispensing aerosol droplets to the process tube.

Item A13. The drying system according to any of the previous items, wherein the liquid chamber of the mesh nebulizer receiving the solution of agent is connected with means to establish a pressure below ambient pressure in said chamber.

Item A14. The drying system according to any of the previous items, wherein the aerosol droplets are in the size range of 1-50 μm.

Item A15. The drying system according to any of the previous items, wherein the membrane sleeve is a thin sheet admitting diffusion of the solvent from process flow to the ascending flow, preferably said membrane has a controlled solvent sorbing capacity; more preferably said sheet is paper sheet having a specific weight of about 14 grams per square meter.

Item A16. The drying system according to any of the previous items, provided with means to supply Met gas to the tube reactor from a gas drying column said means comprising an inlet flow rate measuring device located between said process tube and said gas drying column.

Item A17. The drying system according to any of the previous items, characterized in that it comprises a device introducing inlet gas to the perforated process tube adapted to provide a laminar process flow comprising descending aerosol droplets.

Item A18. The drying system according to any of the previous items, characterized in that the device is generally annular in cross-section, thereby surrounding the nebulizer opening, and is provided with a plurality of outlet orifices arranged along a peripheral area of said device in order to generate a process flow for transporting and directing the aerosol droplets towards a radial center of the process tube.

Item A19. The drying system according to any of the previous items, characterized in that the orifices are angled and arranged with outlet channels having a major axis offset to a cross-sectional radius of the inlet gas device.

Item A20. The drying system according to any of the previous items, wherein the process flow is generated by a vacuum source connected to the bottom of the process tube.

Item A21. The drying system according to any of the previous items, characterized in that the ascending gas flow is a turbulent or laminar flow with a higher flow rate than the descending process flow.

Item A22. The drying system according to any of the previous items, characterized in that the ascending gas flow is adapted to perform a swirling motion around the membrane sleeve.

Item A23. The drying system according to any of the previous items, characterized in that ascending gas flow has a tangential is generated by a vacuum source connected to the tube reactor.

Item A24. The drying system according to any of the previous items, characterized in that the tube reactor has a tangential outlet for the ascending gas flow.

Item A25. The drying system according to any of the previous items, wherein the flow rate of the ascending gas flow is substantially higher than the descending process flow.

Item A26. The drying system according to any of the previous items, wherein the ascending flow has a flow rate from about ten to one hundred and fifty times the value of the descending flow rate to about an equal flow rate value of the descending rate.

Item A27. A method of preparing a composition of dry particles from a solution of an agent comprising the steps of:
(i) providing a composition comprising a payload to a device for generating an aerosol;
(ii) generating a descending process flow in the form of a gas stream of aerosolized droplets with a low flow rate in a perforated process tube;
(iii) generating an ascending gas flow for counter-current removal of solvent from said process flow, said ascending flow having substantially higher flow rate than said descending flow;
(iv) providing a membrane, separating said process flow and ascending gas flow, permitting diffusive transport of vaporized solvent through the membrane from said process flow to said ascending flow for drying the aerosol; and
(v) allowing the process flow to descend in the process tube for a time sufficient to substantially remove all solvent vapors before removing the dry particles from said process flow, and and wherein the method comprises the option of introducing energy into the tube.

Item A28. The method according to item A27, wherein the introduction of energy comprises a heat element which is used to bring heat into the tube from the outside of the tube.

Item A29. The methods according to any of items A27-A28, wherein descending flow is laminar.

Item A30. The methods according to any of items A27-A29 comprising sealingly transporting the solvent-rich ascended gas flow leaving the membrane to a solvent absorption column, transporting it through the column for solvent stripping and letting it re-contact the membrane for ascension through the reactor without generating a radial flow of gas through the membrane.

Item A31. The methods according to any of items A27-A30, comprising tangentially introducing the ascending gas flow to the tube reactor in order to generate a swirling flow around the membrane.

Item A32. The methods according to any of items A27-A31, comprising tangentially removing the ascended gas flow from the tube reactor.

Item A33. The methods according to any of items A27-A32, comprising generating a gently rotating inlet gas flow to the process tube for centrally stabilizing the aerosol dispensed from the aerosol generating device.

Item A34. The methods according to any of items A27-A33, comprising detecting or monitoring the performance of the aerosol generating device by carefully measuring the inlet gas flow to process tube.

Item A35. The methods according to any of items A27-A34, comprising detecting and controlling the flow rate of the solvent stripped flow after the absorption column.

Item A36. The methods according to any of items A27-A35, comprising monitoring the total mass balance of solvent in the system by balancing the disappearance of solvent from the nebulizer against the total outbound flux of solvent from the tube reactor.

Item A37. The methods according to any of items A27-A36, comprising detecting the solvent concentration and flow rates in:
(i) the solvent-containing flow before the absorption column, and
(ii) the effluent gas stream after the particle-collecting device.

Item A38. A method for preparing a dry composition comprising by a counter-current spray drying process comprising:
(i) providing a liquid composition comprising a payload and at least one excipient, nebulizing said composition into transportable droplets of less than 50 μm in a tube reactor having an inner region and an outer region separated by a perforated process tube with an outer periphery covered by a membrane;
(ii) admitting the nebulized composition to descend in a laminar carrier gas flow in said inner region, while admitting a turbulent or laminar flow of dry gas to ascend in said outer region in order to establish a counter-current drying of the descending droplets;
(iii) drying the droplets, while admitting vapor to diffuse through the membrane and into the ascending turbulent or laminar flow of dry gas at a rate that exceeds an opposite flow rate of dry gas radially through the membrane; and
(iv) collecting a dry composition comprising a payload and at least one excipient.

Item B1. A drying system configured to provide a composition of dry particles from a composition comprising a payload, such as a biopharmaceutical, comprising a generally cylindrical tube reactor configured for counter-current removal of solvent from a process flow fed with aerosol droplets of solution descending from the top said reactor with an ascending gas flow, characterized in that the tube reactor comprises:
(i) a perforated process tube for transportation of the process flow from an outlet of an aerosol generating device, capable of generating said aerosol droplets of solution, to a dry particle collecting device;
(ii) a membrane sleeve essentially surrounding the peripheral area of said process tube, wherein the membrane sleeve is configured to separate the descending process flow from the ascending gas flow while admitting diffusion of vaporized solvent from the process flow to the ascending gas flow;
(iii) a reactor housing sealingly covering said process tube and membrane sleeve being provided with means for introducing and/or removing process fluids,
   and wherein the system comprises a first mass flow regulator configured to regulate the ascending gas flow, wherein the first mass flow regulator is configured to control the pressure in the tube reactor by regulating the ascending gas flow.

Item B2. The drying system according to item B2, wherein the system comprises a first pressure sensor at an outlet of the ascending gas flow, wherein the first pressure sensor is configured to provide a first pressure signal to the first mass flow regulator, and wherein the first mass flow regulator is configured to control the pressure in the tube reactor by regulating the ascending gas flow based on the first pressure signal.

Item B3. The drying system according to any of items B1-B2, wherein the system comprises a second mass flow regulator configured to regulate the process flow.

Item B4. The drying system according to item B3, wherein the system comprises a second pressure sensor at an inlet of the process flow, wherein the second pressure sensor is configured to provide a second pressure signal, and wherein the second mass flow regulator is configured to regulate the process flow based on the second pressure signal.

Item B5. The drying system according to items B2 and/or B4, wherein the system comprises one or more static pressure sensors configured to measure a pressure difference between the outlet of the ascending gas flow, the inlet of the process flow, and the outlet of the process flow.

Item B6. The drying system according to any of items B1-B5, wherein the system comprises a first humidity sensor at an outlet of the ascending gas flow and a third humidity sensor at an inlet of the ascending gas flow, wherein the first humidity sensor is configured to provide a first humidity signal and the third humidity sensor is configured to provide a third humidity signal, and wherein the system is configured to determine a humidity parameter of the outlet of the ascending gas flow based on the first humidity signal and/or the third humidity signal.

Item B7. The drying system according to any of items B1-B6, wherein the system comprises a second humidity sensor at an inlet of the process flow and a fourth humidity sensor at an outlet of the process flow, wherein the second humidity sensor is configured to provide a second humidity signal and the fourth humidity sensor is configured to provide a fourth humidity signal, and wherein the system is configured to determine a humidity parameter of the outlet of the process flow based on the second humidity signal and/or the fourth humidity signal.

Item B8. The drying system according to item B6 and/or B7, wherein the first humidity sensor, the second humidity sensor, the third humidity sensor, and/or the fourth humidity sensor comprise a dew point sensor.

Item B9. The drying system according to any of items B1-B8, wherein the system comprises one or more temperature sensors configured to provide one or more temperature signals.

Item B10. The drying system according to any of items B6-B9, wherein the system is configured to monitor mass transfer of solvent based on one or more of: the first humidity signal, the second humidity signal, the third humidity signal, the fourth humidity signal, the process flow, the ascending gas flow, and the one or more temperature signals.

Item B11. The drying system according to any of items B1-B10, wherein the system comprises a heat element configured to provide energy into the tube reactor.

Item B12. The drying system according to item B11, wherein the heat element is configured to bring heat into the tube reactor from the outside of the tube reactor.

Item B13. The drying system according to any of items B11-B12, wherein the heat element is selected from the group consisting of one or more of: a mantel, a dry bath, a resistance element, an incubator, and an infrared heater.

Item B14. The drying system according to any of items B11-B13, wherein the system is configured to control mass transfer of solvent by controlling one or more of: the heat element, the process flow, the ascending gas flow, and a spray rate of the aerosol generating device.

Item B15. The drying system according to any of items B1-B14, wherein the system is configured to determine a temperature inside the tube reactor.

Item B16. The drying system according to any of items B1-B15, wherein the aerosol generating device located at the top of the tube reactor is a downward acting mesh nebulizer, provided with an opening in its bottom part for dispensing aerosol droplets to the process tube.

Item B17. The drying system according to item B16, wherein a liquid chamber of the mesh nebulizer receiving the solution of agent is connected with means to establish a pressure below ambient pressure in said chamber.

Item B18. The drying system according to any of items B1-B17, wherein the aerosol generating device is configured to generate aerosol droplets in the size range of 1-50 μm.

Item B19. The drying system according to any of items B1-B18, wherein the membrane sleeve is a thin sheet admitting diffusion of the solvent from process flow to the ascending flow, preferably said membrane has a controlled solvent sorbing capacity; more preferably said sheet comprises one or more of: paper, such as including rice paper, other polymer membranes with hydrophilic or hydrophobic surfaces, e.g., modified cellulose, polyether sulfone, PES, and nylon.

Item B20. The drying system according to any of items B1-B19, provided with means configured to supply a gas flow to the tube reactor from a gas drying column, said means comprising an inlet flow rate measuring device located between said process tube and said gas drying column.

Item B21. The drying system according to any of items B1-B20, wherein the system comprises a first gas inlet for the process flow arranged at a top portion of the process tube, wherein the first gas inlet is configured to introduce inlet gas to the perforated process tube for provision of a laminar process flow comprising descending aerosol droplets.

Item B22. The drying system according to item B21, wherein the first gas inlet is generally annular in cross-section, thereby surrounding the aerosol generator device opening, and is provided with a plurality of outlet orifices arranged along a peripheral area of said first gas inlet in order to generate a process flow for transporting and directing the aerosol droplets towards a radial center of the process tube.

Item B23. The drying system according to item B22, characterized in that the orifices are angled and arranged with outlet channels having a major axis offset to a cross-sectional radius of the first gas inlet.

Item B24. The drying system according to any of items B1-B23, wherein the system comprises a first vacuum source connected to one or more of: the outlet of the process flow, the outlet of the ascending gas flow, and the outlet of the container/glovebox.

Item B25. The drying system according to any of items B1-B24, characterized in that the ascending gas flow is a turbulent or laminar flow with a higher flow rate than the descending process flow.

Item B26. The drying system according to any of items B1-B25, wherein the system comprises a second gas inlet for the ascending gas flow arranged tangentially to the tube reactor so that the second gas inlet is configured to introduce inlet gas such that the ascending gas flow performs a swirling motion around the membrane sleeve.

Item B27. The drying system according to any of items B1-B26, characterized in that the tube reactor has a tangential inlet for the ascending gas flow.

Item B28. The drying system according to any of items B1-B27, wherein the system comprises a second vacuum source connected to the top of the tube reactor configured to contribute generating the ascending gas flow.

Item B29. The drying system according to any of items B1-B28, wherein the system comprises a second gas outlet for the ascending gas flow arranged tangentially to the tube reactor.

Item B30. The drying system according to any of items B1-B29, wherein the flow rate of the ascending gas flow is substantially higher than the descending process flow.

Item B31. The drying system according to any of items B1-B30, wherein the ascending gas flow has a flow rate from about ten to one hundred times the value of the descending process flow rate to about an equal flow rate value of the descending process flow rate.

Item B32. The drying system according to any of items B1-B31, wherein the drying system is a spray drying system.

Item B33. The drying system according to any of items B1-B32, wherein the system comprises a mesh arranged at the bottom end of the process tube for supporting the particle collecting device.

Item B34. The drying system according to any of items B1-B33, wherein the system comprises a container arranged at the bottom end of the process tube for accumulating and/or storing the dry particles of the composition.

Item B35. The drying system according to any of items B1-B34, wherein the system comprises a glovebox arranged at the bottom end of the tube reactor.

Item B36. The drying system according to item B35, wherein the system comprises a third mass flow regulator configured to regulate an inlet gas flow of the glovebox.

Item B37. The drying system according to any of items B35-B36, wherein the system comprises a third pressure sensor at an outlet gas flow of the glovebox and a sixth mass flow regulator configured to regulate the outlet gas flow of the glovebox, wherein the third pressure sensor is configured to provide a third pressure signal, and wherein the sixth mass flow regulator is configured to regulate the outlet process flow based on the third pressure signal.

Item B38. The drying system according to any of items B35-B37, wherein the glovebox comprises a fifth humidity sensor for monitoring humidity in the glovebox.

Item B39. The drying system according to any of items B35-B38, wherein the system comprises a side-box arranged at the glovebox, wherein an outlet hatch is arranged between the side-box and the glovebox for extracting a product.

Item B40. A method of preparing a composition of dry particles from a solution of an agent using the drying system of any of items B1-B39, the method comprising the steps of:
(i) providing a composition comprising a payload to an aerosol generating device;
(ii) generating a descending process flow in the form of a gas stream of aerosolized droplets in a tube reactor having an inner region and an outer region separated by a perforated process tube with an outer periphery covered by a membrane;
(iii) generating an ascending gas flow for counter-current removal of solvent from said process flow;
(iv) controlling the pressure of a tube reactor by regulating the ascending gas flow;
(v) separating using the membrane said process flow and ascending gas flow, permitting diffusive transport of vaporized solvent through the membrane from said process flow to said ascending flow for drying the aerosol;
(vi) drying the droplets, while admitting vapor to diffuse through the membrane and into the ascending turbulent or laminar flow of dry gas at a rate that exceeds an opposite flow rate of dry gas radially through the membrane; and
(vii) collecting a dry composition comprising the payload.

Item B41. The method according to item B40, the method comprising monitoring mass transfer of solvent based on humidity and/or temperature measurements.

Item B42. The method according to any of items B40-B41, the method comprising providing energy into the tube reactor by heating the tube reactor from outside.

Item B43. The method according to any of items B40-B42, the method comprising sealingly transporting the solvent-rich ascended gas flow leaving the membrane to a solvent absorption column, transporting it through the column for solvent stripping and letting it re-contact the membrane for ascension through the reactor without generating a radial flow of gas through the membrane.

Item B44. The method according to any of items B40-B42, the method comprising tangentially introducing the ascending gas flow to the tube reactor in order to generate a swirling flow around the membrane.

Item B45. The method according to any of items B40-B44, the method comprising tangentially removing the ascended gas flow from the tube reactor.

Item B46. The method according to any of items B40-B45, the method comprising generating a rotating inlet gas flow to the process tube for centrally stabilizing the aerosol dispensed from the aerosol generating device.

Item B47. The method according to any of items B40-B46, the method comprising detecting and controlling the flow rate of the solvent stripped flow after the absorption column.

Item B48. The method according to any of items B40-B47, the method comprising monitoring the total mass balance of solvent in the system by balancing the disappearance of solvent from the nebulizer against the total outbound flux of solvent from the tube reactor.

Item B49. The method according to any of items B40-B48, the method comprising detecting the solvent concentration and flow rates in:
(i) the solvent-containing flow before the absorption column, and
(ii) the effluent gas stream after the particle-collecting device.

Item B50. The method according to any of items B40-B49, the method comprising:
providing a liquid composition comprising a payload and at least one excipient, nebulizing said composition into transportable droplets of less than 50 μm in the tube reactor;
drying the droplets, while admitting vapor to diffuse through the membrane and into the ascending turbulent or laminar flow of dry gas at a rate that exceeds an opposite flow rate of dry gas radially through the membrane; and
collecting a dry composition comprising the payload and at the least one excipient.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa. It may be appreciated that the Figures comprise some circuitries or operations which are illustrated with a solid line and some circuitries, components, features, or operations which are illustrated with a dashed line. Circuitries or operations which are comprised in a solid line are circuitries, components, features or operations which are comprised in the broadest example. Circuitries, components, features, or operations which are comprised in a dashed line are examples which may be comprised in, or a part of, or are further circuitries, components, features, or operations which may be taken in addition to circuitries, components, features, or operations of the solid line examples. It should be appreciated that these operations need not be performed in order presented. Furthermore, it should be appreciated that not all of the operations need to be performed. The example operations may be performed in any order and in any combination. It should be appreciated that these operations need not be performed in order presented. Circuitries, components, features, or operations which are comprised in a dashed line may be considered optional.

Other operations that are not described herein can be incorporated in the example operations. For example, one or more additional operations can be performed before, after, simultaneously, or between any of the described operations.

Certain features discussed above as separate implementations can also be implemented in combination as a single implementation. Conversely, features described as a single implementation can also be implemented in multiple implementations separately or in any suitable sub-combination. Moreover, although features may be described above as acting in certain combinations, one or more features from a claimed combination can, in some cases, be excised from the combination, and the combination may be claimed as any sub-combination or variation of any sub-combination.

It is to be noted that the word “comprising” does not necessarily exclude the presence of other elements or steps than those listed.

It is to be noted that the words “a” or “an” preceding an element do not exclude the presence of a plurality of such elements.

It is to be noted that the term “indicative of” may be seen as “associated with”, “related to”, “descriptive of”, “characterizing”, and/or “defining”. The terms “indicative of”, “associated with” “related to”, “descriptive of”, “characterizing”, and “defining” can be used interchangeably. The term “indicative of” can be seen as indicating a relation. For example, weight data indicative of weight may comprise one or more weight parameters.

It is to be noted that the word “based on” may be seen as “as a function of” and/or “derived from”. The terms “based on” and “as a function of” can be used interchangeably. For example, a parameter determined “based on” a data set can be seen as a parameter determined “as a function of” the data set. In other words, the parameter may be an output of one or more functions with the data set as an input.

A function may be characterizing a relation between an input and an output, such as mathematical relation, a database relation, a hardware relation, logical relation, and/or other suitable relations.

It should further be noted that any reference signs do not limit the scope of the claims, that the examples may be implemented at least in part by means of both hardware and software, and that several “means”, “units” or “devices” may be represented by the same item of hardware.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

### LIST OF REFERENCES

1 drying system
2 cabinet
10 second mass flow regulator
11 second pressure signal
12 second filter
14 second pressure sensor
16 second humidity sensor
20 first mass flow regulator
21 first pressure signal
22 first filter
26 third humidity sensor
30 third mass flow regulator
31 glove opening
32 third filter
33 inspection window
34 glovebox
35 side-box
36 fifth humidity sensor
37 overpressure valve
39 container, particle collecting device
40 fourth mass flow regulator
41 safety valve
42 fourth filter
43 environment pressure sensor
44 first pressure sensor
46 first humidity sensor
50 fifth mass flow regulator
56 fourth humidity sensor
60 sixth mass flow regulator
61 third pressure signal
64 third pressure sensor
71 gas distribution column
73 outlet column
79 static pressure sensor(s)
81 process tube
82 aerosol generating device
83 reactor housing
84 bottom holder for membrane
85 membrane
86 mesh
87 tube reactor
88 mesh holder
89 product outlet
91 bottom end
AF_i second gas inlet
AF_o second gas outlet
PF_i process flow inlet

1. A drying system configured to provide a composition of dry particles from a composition comprising a payload, such as a biopharmaceutical, comprising a generally cylindrical tube reactor configured for counter-current removal of solvent from a process flow fed with aerosol droplets of solution descending from the top said reactor with an ascending gas flow, characterized in that the tube reactor comprises:
(i) a perforated process tube for transportation of the process flow from an outlet of an aerosol generating device, capable of generating said aerosol droplets of solution, to a dry particle collecting device;
(ii) a membrane sleeve essentially surrounding the peripheral area of said process tube, wherein the membrane sleeve is configured to separate the descending process flow from the ascending gas flow while admitting diffusion of vaporized solvent from the process flow to the ascending gas flow;
(iii) a reactor housing sealingly covering said process tube and membrane sleeve being provided with means for introducing and/or removing process fluids,
and wherein the system comprises a first mass flow regulator configured to regulate the ascending gas flow, wherein the first mass flow regulator is configured to control the pressure in the tube reactor by regulating the ascending gas flow.

2. The drying system according to claim 1, wherein the system comprises a first pressure sensor at an outlet of the ascending gas flow, wherein the first pressure sensor is configured to provide a first pressure signal to the first mass flow regulator, and wherein the first mass flow regulator is configured to control the pressure in the tube reactor by regulating the ascending gas flow based on the first pressure signal.

3. The drying system according to any of the previous claims, wherein the system comprises a second mass flow regulator configured to regulate the process flow.

4. The drying system according to claim 3, wherein the system comprises a second pressure sensor at an inlet of the process flow, wherein the second pressure sensor is configured to provide a second pressure signal, and wherein the second mass flow regulator is configured to regulate the process flow based on the second pressure signal.

5. The drying system according to claims 2 and/or 4, wherein the system comprises one or more static pressure sensors configured to measure a pressure difference between the outlet of the ascending gas flow, the inlet of the process flow, and the outlet of the process flow.

6. The drying system according to any of the previous claims, wherein the system comprises a first humidity sensor at an outlet of the ascending gas flow and a third humidity sensor at an inlet of the ascending gas flow, wherein the first humidity sensor is configured to provide a first humidity signal and the third humidity sensor is configured to provide a third humidity signal, and wherein the system is configured to determine a humidity parameter of the outlet of the ascending gas flow based on the first humidity signal and/or the third humidity signal.

7. The drying system according to any of the previous claims, wherein the system comprises a second humidity sensor at an inlet of the process flow and a fourth humidity sensor at an outlet of the process flow, wherein the second humidity sensor is configured to provide a second humidity signal and the fourth humidity sensor is configured to provide a fourth humidity signal, and wherein the system is configured to determine a humidity parameter of the outlet of the process flow based on the second humidity signal and/or the fourth humidity signal.

8. The drying system according to claim 6 and/or 7, wherein the first humidity sensor, the second humidity sensor, the third humidity sensor, and/or the fourth humidity sensor comprise a dew point sensor.

9. The drying system according to any of the previous claims, wherein the system comprises one or more temperature sensors configured to provide one or more temperature signals.

10. The drying system according to any of claims 6-9, wherein the system is configured to monitor mass transfer of solvent based on one or more of: the first humidity signal, the second humidity signal, the third humidity signal, the fourth humidity signal, the process flow, the ascending gas flow, and the one or more temperature signals.

11. The drying system according to any of the previous claims, wherein the system comprises a heat element configured to provide energy into the tube reactor.

12. The drying system according to claim 11, wherein the heat element is configured to bring heat into the tube reactor from the outside of the tube reactor.

13. The drying system according to any of claims 11-12, wherein the heat element is selected from the group consisting of one or more of: a mantel, a resistance element, a dry bath, an incubator, and an infrared heater.

14. The drying system according to any of claims 11-13, wherein the system is configured to control mass transfer of solvent by controlling one or more of: the heat element, the process flow, the ascending gas flow, and a spray rate of the aerosol generating device.

15. The drying system according to any of the previous claims, wherein the system is configured to determine a temperature inside the tube reactor.

16. The drying system according to any of the previous claims, wherein the aerosol generating device located at the top of the tube reactor is a downward acting mesh nebulizer, provided with an opening in its bottom part for dispensing aerosol droplets to the process tube.

17. The drying system according to claim 16, wherein a liquid chamber of the mesh nebulizer receiving the solution of agent is connected with means to establish a pressure below ambient pressure in said chamber.

18. The drying system according to any of the previous claims, wherein the aerosol generating device is configured to generate aerosol droplets in the size range of 1-50 μm.

19. The drying system according to any of the previous claims, wherein the membrane sleeve is a thin sheet admitting diffusion of the solvent from process flow to the ascending flow, preferably said membrane has a controlled solvent sorbing capacity; more preferably said sheet comprises one or more of: paper, such as including rice paper, other polymer membranes with hydrophilic or hydrophobic surfaces, e.g., modified cellulose, polyether sulfone, PES, and nylon.

20. The drying system according to any of the previous claims, provided with means configured to supply a gas flow to the tube reactor from a gas drying column, said means comprising an inlet flow rate measuring device located between said process tube and said gas drying column.

21. The drying system according to any of the previous claims, wherein the system comprises a first gas inlet for the process flow arranged at a top portion of the process tube, wherein the first gas inlet is configured to introduce inlet gas to the perforated process tube for provision of a laminar process flow comprising descending aerosol droplets.

22. The drying system according to claim 21, wherein the first gas inlet is generally annular in cross-section, thereby surrounding the aerosol generator device opening, and is provided with a plurality of outlet orifices arranged along a peripheral area of said first gas inlet in order to generate a process flow for transporting and directing the aerosol droplets towards a radial center of the process tube.

23. The drying system according to claim 22, characterized in that the orifices are angled and arranged with outlet channels having a major axis offset to a cross-sectional radius of the first gas inlet.

24. The drying system according to any of the previous claims, wherein the system comprises a first vacuum source connected to one or more of: an outlet of the process flow, an outlet of the ascending gas flow, and an outlet of the container and/or glovebox.

25. The drying system according to any of the previous claims, characterized in that the ascending gas flow is a turbulent or laminar flow with a higher flow rate than the descending process flow.

26. The drying system according to any of the previous claims, wherein the system comprises a second gas inlet for the ascending gas flow arranged tangentially to the tube reactor so that the second gas inlet is configured to introduce inlet gas such that the ascending gas flow performs a swirling motion around the membrane sleeve.

27. The drying system according to any of the previous claims, characterized in that the tube reactor has a tangential inlet for the ascending gas flow.

28. The drying system according to any of the previous claims, wherein the system comprises a second vacuum source connected to one or more of: the outlet of the process flow, the outlet of the ascending gas flow, and the outlet of the container/glovebox.

29. The drying system according to any of the previous claims, wherein the system comprises a second gas outlet for the ascending gas flow arranged tangentially to the tube reactor.

30. The drying system according to any of the previous claims, wherein the flow rate of the ascending gas flow is substantially higher than the descending process flow.

31. The drying system according to any of the previous claims, wherein the ascending gas flow has a flow rate from about ten to one hundred and fifty times the value of the descending process flow rate to about an equal flow rate value of the descending process flow rate.

32. The drying system according to any of previous claims, wherein the drying system is a spray drying system.

33. The drying system according to any of previous claims, wherein the system comprises a mesh arranged at the bottom end of the process tube for supporting the particle collecting device.

34. The drying system according to any of previous claims, wherein the system comprises a container arranged at the bottom end of the process tube for accumulating and/or storing the dry particles of the composition.

35. The drying system according to any of previous claims, wherein the system comprises a glovebox arranged at the bottom end of the tube reactor.

36. The drying system according to claim 35, wherein the system comprises a third mass flow regulator configured to regulate an inlet gas flow of the glovebox.

37. The drying system according to any of claims 35-36, wherein the system comprises a third pressure sensor at an outlet gas flow of the glovebox and a sixth mass flow regulator configured to regulate the outlet gas flow of the glovebox, wherein the third pressure sensor is configured to provide a third pressure signal, and wherein the sixth mass flow regulator is configured to regulate the outlet process flow based on the third pressure signal.

38. The drying system according to any of claims 35-37, wherein the glovebox comprises a fifth humidity sensor for monitoring humidity in the glovebox.

39. The drying system according to any of claims 35-38, wherein the system comprises a side-box arranged at the glovebox, wherein an outlet hatch is arranged between the side-box and the glovebox for extracting a product.

40. A method of preparing a composition of dry particles from a solution of an agent using the drying system of any of claims 1-39, the method comprising the steps of:
(i) providing a composition comprising a payload to an aerosol generating device;
(ii) generating a descending process flow in the form of a gas stream of aerosolized droplets in a tube reactor having an inner region and an outer region separated by a perforated process tube with an outer periphery covered by a membrane;
(iii) generating an ascending gas flow for counter-current removal of solvent from said process flow;
(iv) controlling the pressure of a tube reactor by regulating the ascending gas flow;
(v) separating using the membrane said process flow and ascending gas flow, permitting diffusive transport of vaporized solvent through the membrane from said process flow to said ascending flow for drying the aerosol;
(vi) drying the droplets, while admitting vapor to diffuse through the membrane and into the ascending turbulent or laminar flow of dry gas at a rate that exceeds an opposite flow rate of dry gas radially through the membrane; and
(vii) collecting a dry composition comprising the payload.

41. The method according to claim 40, the method comprising monitoring mass transfer of solvent based on humidity and/or temperature measurements.

42. The method according to any of claims 40-41, the method comprising providing energy into the tube reactor by heating the tube reactor from outside and/or the inside of the tube reactor.

43. The method according to any of claims 40-42, the method comprising: rec-circulating the ascending gas flow by sealingly transporting the solvent-rich ascended gas flow leaving the membrane to a solvent absorption column, transporting it through the column for solvent stripping and letting it re-contact the membrane for ascension through the reactor without generating a radial flow of gas through the membrane.

44. The method according to any of claims 40-42, the method comprising tangentially introducing the ascending gas flow to the tube reactor in order to generate a swirling flow around the membrane.

45. The method according to any of claims 40-44, the method comprising tangentially removing the ascended gas flow from the tube reactor.

46. The method according to any of claims 40-45, the method comprising generating a rotating inlet gas flow to the process tube for centrally stabilizing the aerosol dispensed from the aerosol generating device.

47. The method according to any of claims 40-46, the method comprising detecting and controlling the flow rate of the solvent stripped flow after the absorption column.

48. The method according to any of claims 40-47, the method comprising monitoring the total mass balance of solvent in the system by balancing the disappearance of solvent from the nebulizer against the total outbound flux of solvent from the tube reactor.

49. The method according to any of claims 40-48, the method comprising detecting the solvent concentration and flow rates in:
(i) the solvent-containing flow before the absorption column, and
(ii) the effluent gas stream after the particle-collecting device.

50. The method according to any of claims 40-49, the method comprising:
providing a liquid composition comprising a payload and at least one excipient, nebulizing said composition into transportable droplets of less than 50 μm in the tube reactor;
drying the droplets, while admitting vapor to diffuse through the membrane and into the ascending turbulent or laminar flow of dry gas at a rate that exceeds an opposite flow rate of dry gas radially through the membrane; and
collecting a dry composition comprising the payload and at the least one excipient.
